(19) United States
(12) Patent Application Publication
(10) Pub. No.: US 2026/0031560 A1
(43) Pub. Date: Jan. 29, 2026

(54) Electrical Connector

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/283,881

(22) Filed: Jul. 29, 2025

(30) Foreign Application Priority Data
Jul. 29, 2024 (TW) 113128190

(51) Int. Cl. H01R 12/75; H01R 13/506; H01R 13/6591; H01R 13/6599

(52) U.S. Cl. CPC H01R 12/75; H01R 13/506; H01R 13/65914; H01R 13/6599

(57) ABSTRACT

A conductive component module and electrical connector thereof, wherein the conductive component module comprises: an engaging conductive component, a joining conductive component, and an electrical connector. The electrical connector comprises a conductive terminal set that can engage the engaging conductive component to transmit signals, and also join the joining conductive component to transmit signals. The conductive terminal set comprises a ground terminal and a signal terminal, wherein the ground terminal is configured to provide shielding for the signal terminal to reduce the degree of interference with signal transmission of the signal terminal, thereby meeting the signal transmission requirement of the electrical connector.

### CROSS REFERENCE TO RELATED APPLICATIONS

This application claims the priority of Republic of China Patent Application No. 113128190 filed on Jul. 29, 2024, in the State Intellectual Property Office of the R.O.C., the disclosure of which is incorporated herein by reference.

### BACKGROUND OF THE INVENTION

### Field of the Invention

The present application relates to electronic devices, and more particularly, to a conductive component module capable of providing shielding for signal terminals to meet signal transmission requirements, and an electrical connector of the conductive component module.

### Descriptions of the Related Art

In recent years, electrical connectors have been widely used in various electronic devices. However, with the development and increasing demands of such electronic devices, the requirements for signal transmission in electrical connectors have grown significantly. Existing electrical connectors, due to limitations in mechanical design, often provide inadequate shielding, resulting in signal transmission being susceptible to interference. This leads to issues such as signal attenuation and distortion during transmission, making it difficult for the electrical connectors to meet signal transmission requirements. The aforementioned interference may comprise, for example, electromagnetic interference (EMI) or noise induced crosstalk interference.

Therefore, how to reduce interference during the signal transmission process in electrical connectors has become an urgent problem to be solved by those skilled in the art.

### SUMMARY OF THE INVENTION

In view of the drawbacks of the prior art mentioned above, the present application provides an electrical connector comprising: an electrical connector body comprising a major terminal engaging structure arrangement region, the major terminal engaging structure arrangement region comprising a major terminal engaging structure arrangement region long side and a major terminal engaging structure arrangement region short side, wherein the major terminal engaging structure arrangement region long side is located at a long side of the major terminal engaging structure arrangement region, and the major terminal engaging structure arrangement region short side is located at a short side of the major terminal engaging structure arrangement region; and a major conductive terminal set, one end of the major conductive terminal set being a major conductive terminal set engaging end, the major conductive terminal set comprising a major signal terminal and a first major ground terminal, wherein the major signal terminal and the first major ground terminal respectively comprise a major signal terminal engaging structure and a first major ground terminal engaging structure at the major conductive terminal set engaging end, and the major signal terminal engaging structure and the first major ground terminal engaging structure are provided in the major terminal engaging structure arrangement region, wherein, a cross section of the major signal terminal engaging structure in the major terminal engaging structure arrangement region is a major signal terminal engaging structure cross section, the major signal terminal engaging structure cross section comprising a major signal terminal engaging structure cross section long side and a major signal terminal engaging structure cross section short side which are respectively located at a long side and a short side of the major signal terminal engaging structure cross section; a cross section of the first major ground terminal engaging structure in the major terminal engaging structure arrangement region is a first major ground terminal engaging structure cross section, the first major ground terminal engaging structure cross section comprising a first major ground terminal engaging structure cross section long side and a first major ground terminal engaging structure cross section short side which are respectively located at a long side and a short side of the first major ground terminal engaging structure cross section; the major signal terminal engaging structure cross section long side is extended along the major terminal engaging structure arrangement region long side, and the major signal terminal engaging structure cross section short side is extended along the major terminal engaging structure arrangement region short side; and the first major ground terminal engaging structure cross section long side is extended along the major terminal engaging structure arrangement region short side, and an extension length of the first major ground terminal engaging structure cross section long side is greater than an extension length of the major signal terminal engaging structure cross section short side, such that the first major ground terminal engaging structure provides shielding for the major signal terminal engaging structure at the major terminal engaging structure arrangement region short side.

Preferably, the electrical connector said above, wherein the electrical connector body further comprises a minor terminal engaging structure arrangement region, and the minor terminal engaging structure arrangement region comprises a minor terminal engaging structure arrangement region long side and a minor terminal engaging structure arrangement region short side, wherein the minor terminal engaging structure arrangement region long side and the minor terminal engaging structure arrangement region short side are respectively located at a long side and a short side of the minor terminal engaging structure arrangement region, and the electrical connector further comprises a minor conductive terminal set and a conductive metal connecting component, wherein, one end of the minor conductive terminal set is a minor conductive terminal set engaging end, and the minor conductive terminal set comprises a minor signal terminal and a first minor ground terminal which respectively comprise a minor signal terminal engaging structure and a first minor ground terminal engaging structure at the minor conductive terminal set engaging end, wherein the minor signal terminal engaging structure and the first minor ground terminal engaging structure are provided in the minor terminal engaging structure arrangement region; a cross section of the minor signal terminal engaging structure in the minor terminal engaging structure arrangement region is a minor signal terminal engaging structure cross section, the minor signal terminal engaging structure cross section comprising a minor signal terminal engaging structure cross section long side and a minor signal terminal engaging structure cross section short side which are respectively located at a long side and a short side of the minor signal terminal engaging structure cross section; a cross section of the first minor ground terminal engaging structure in the minor terminal engaging structure arrangement region is a first minor ground terminal engaging structure cross section, the minor ground terminal engaging structure cross section comprising a first minor ground terminal engaging structure cross section long side and a first minor ground terminal engaging structure cross section short side which are respectively located at a long side and a short side of the minor ground terminal engaging structure cross section; the minor signal terminal engaging structure cross section long side is extended along the minor terminal engaging structure arrangement region long side, and the minor signal terminal engaging structure cross section short side is extended along the minor terminal engaging structure arrangement region short side; and the first minor ground terminal engaging structure cross section long side is extended along the minor terminal engaging structure arrangement region short side, and an extension length of the first minor ground terminal engaging structure cross section long side is greater than an extension length of the minor signal terminal engaging structure cross section short side, such that the first minor ground terminal engaging structure provides shielding for the minor signal terminal engaging structure at the minor terminal engaging structure arrangement region short side; and the conductive metal connecting component is located between the major conductive terminal set and the minor conductive terminal set and is electrically connected to the first major ground terminal and the first minor ground terminal respectively to transmit a shielding signal and provide shielding for the major conductive terminal set and the minor conductive terminal set.

Preferably, the electrical connector said above, wherein the major conductive terminal set further comprises a second major ground terminal, the second major ground terminal comprising a second major ground terminal engaging structure at the major conductive terminal set engaging end, the second major ground terminal engaging structure being provided in the major terminal engaging structure arrangement region, wherein a cross section of the second major ground terminal engaging structure in the major terminal engaging structure arrangement region is a second major ground terminal engaging structure cross section, the second major ground terminal engaging structure cross section comprising a second major ground terminal engaging structure cross section long side and a second major ground terminal engaging structure cross section short side which are respectively located at a long side and a short side of the second major ground terminal engaging structure cross section; wherein the second major ground terminal engaging structure cross section long side is extended along the major terminal engaging structure arrangement region short side, and an extension length of the second major ground terminal engaging structure cross section long side is greater than the extension length of the major signal terminal engaging structure cross section short side, such that the second major ground terminal engaging structure provides shielding for the major signal terminal engaging structure at the major terminal engaging structure arrangement region short side; and the major terminal engaging structure arrangement region comprises a major signal terminal engaging structure arrangement subregion, a first major ground terminal engaging structure arrangement subregion, and a second major ground terminal engaging structure arrangement subregion, wherein the major signal terminal engaging structure arrangement subregion is located between the first major ground terminal engaging structure arrangement subregion and the second major ground terminal engaging structure arrangement subregion, and wherein the major signal terminal engaging structure arrangement subregion is configured to accommodate the major signal terminal engaging structure, the first major ground terminal engaging structure arrangement subregion is configured to accommodate the first major ground terminal engaging structure, and the second major ground terminal engaging structure arrangement subregion is configured to accommodate the second major ground terminal engaging structure.

Preferably, the electrical connector said above, wherein the minor conductive terminal set further comprises a second minor ground terminal, the second minor ground terminal comprising a second minor ground terminal engaging structure at the minor conductive terminal set engaging end, the second minor ground terminal engaging structure being provided in the minor terminal engaging structure arrangement region, wherein a cross section of the second minor ground terminal engaging structure in the minor terminal engaging structure arrangement region is a second minor ground terminal engaging structure cross section, the second minor ground terminal engaging structure cross section comprising a second minor ground terminal engaging structure cross section long side and a second minor ground terminal engaging structure cross section short side which are respectively located at a long side and a short side of the second minor ground terminal engaging structure cross section; the second minor ground terminal engaging structure cross section long side is extended along the minor terminal engaging structure arrangement region short side, and an extension length of the second minor ground terminal engaging structure cross section long side is greater than the extension length of the minor signal terminal engaging structure cross section short side, such that the second minor ground terminal engaging structure provides shielding for the minor signal terminal engaging structure at the minor terminal engaging structure arrangement region short side; and the minor terminal engaging structure arrangement region comprises a minor signal terminal engaging structure arrangement subregion, a first minor ground terminal engaging structure arrangement subregion, and a second minor ground terminal engaging structure arrangement subregion, wherein the minor signal terminal engaging structure arrangement subregion is located between the first minor ground terminal engaging structure arrangement subregion and the second minor ground terminal engaging structure arrangement subregion, and wherein the minor signal terminal engaging structure arrangement subregion is configured to accommodate the minor signal terminal engaging structure, the first minor ground terminal engaging structure arrangement subregion is configured to accommodate the first minor ground terminal engaging structure, and the second minor ground terminal engaging structure arrangement subregion is configured to accommodate the second minor ground terminal engaging structure; and the conductive metal connecting component is further electrically connected to the second major ground terminal and the second minor ground terminal to transmit the shielding signal and provide shielding to the major conductive terminal set and the minor conductive terminal set.

Preferably, the electrical connector said above, wherein the major terminal engaging structure arrangement region is a rectangular region; the major signal terminal engaging structure cross section is a rectangular cross section; the first major ground terminal engaging structure cross section is a rectangular cross section; the second major ground terminal engaging structure cross section is a rectangular cross section; the minor terminal engaging structure arrangement region is a rectangular region; the minor signal terminal engaging structure cross section is a rectangular cross section; the first minor ground terminal engaging structure cross section is a rectangular cross section; and the second minor ground terminal engaging structure cross section is a rectangular cross section.

Preferably, the electrical connector said above further comprising: a major conductive plastic connecting subcomponent configured to be electrically connected to the first major ground terminal, the second major ground terminal, and the conductive metal connecting component respectively, so as to transmit the shielding signal; and a minor conductive plastic connecting subcomponent configured to be electrically connected to the first minor ground terminal, the second minor ground terminal, and the conductive metal connecting component respectively, so as to transmit the shielding signal.

Preferably, the electrical connector said above, further comprising a conductive plastic connecting component, wherein the first major ground terminal, the second major ground terminal, the first minor ground terminal, and the second minor ground terminal respectively abut the conductive plastic connecting component, and the conductive metal connecting component is inserted into the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

Preferably, the electrical connector said above further comprising a conductive plastic connecting component, wherein the first major ground terminal, the second major ground terminal, the first minor ground terminal, and the second minor ground terminal are respectively inserted into the conductive plastic connecting component, and the conductive metal connecting component abuts the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

Preferably, the electrical connector said above, wherein another end of the major conductive terminal set is a major conductive terminal set joining end, and the major signal terminal comprises a major signal terminal joining structure at the major conductive terminal set joining end, wherein the conductive metal connecting component is extended from the major conductive terminal set engaging end to the major conductive terminal set joining end, so as to provide shielding for the major signal terminal engaging structure and the major signal terminal joining structure respectively; and another end of the minor conductive terminal set is a minor conductive terminal set joining end, and the minor signal terminal comprises a minor signal terminal joining structure at the minor conductive terminal set joining end, wherein the conductive metal connecting component is extended from the minor conductive terminal set engaging end to the minor conductive terminal set joining end, so as to provide shielding for the minor signal terminal engaging structure and the minor signal terminal joining structure respectively.

Preferably, the electrical connector said above further comprising a first ground terminal connecting member and a second ground terminal connecting member, wherein the first ground terminal connecting member is connected to the first major ground terminal and the first minor ground terminal, such that the first ground terminal connecting member, the first major ground terminal, and the first minor ground terminal form an I shaped structure, and the first ground terminal connecting member is electrically connected to the first major ground terminal and the first minor ground terminal; the second ground terminal connecting member is connected to the second major ground terminal and the second minor ground terminal, such that the second ground terminal connecting member, the second major ground terminal, and the second minor ground terminal form an I shaped structure, and the second ground terminal connecting member is electrically connected to the second major ground terminal and the second minor ground terminal; the conductive metal connecting component comprises a first connecting member passage and a second connecting member passage, wherein the first ground terminal connecting member passes through the first connecting member passage and is electrically connected to the conductive metal connecting component, and the second ground terminal connecting member passes through the second connecting member passage and is electrically connected to the conductive metal connecting component.

Preferably, the electrical connector said above, wherein the first major ground terminal, the second major ground terminal, the first minor ground terminal, and the second minor ground terminal respectively abut the conductive metal connecting component, such that the first major ground terminal, the second major ground terminal, the first minor ground terminal, and the second minor ground terminal are respectively electrically connected to the conductive metal connecting component.

Furthermore, the present application provides a conductive component module. The conductive component module comprises: an engaging conductive component; a joining conductive component; and the aforementioned electrical connector. The major signal terminal engaging structure, the first major grounding terminal engaging structure, the second major grounding terminal engaging structure, the minor signal terminal engaging structure, the first minor grounding terminal engaging structure, and the second minor grounding terminal engaging structure are provided to engage the engaging conductive component. The major signal terminal joining structure, the first major grounding terminal joining structure, the second major grounding terminal joining structure, the minor signal terminal joining structure, the first minor grounding terminal joining structure, and the second minor grounding terminal joining structure are provided to join the joining conductive component.

Preferably, the conductive component module said above, the engaging conductive component is an engaging connector or an engaging plate, and the joining conductive component is a joining plate or a joining cable.

Additionally, the present application provides an electrical connector comprising: a major conductive terminal set, one end of the major conductive terminal set being a major conductive terminal set engaging end, the major conductive terminal set comprising a major signal terminal and a first major ground terminal, wherein the major signal terminal and the first major ground terminal respectively comprise a major signal terminal engaging structure and a first major ground terminal engaging structure at the major conductive terminal set engaging end, and the major signal terminal engaging structure and the first major ground terminal engaging structure are extended respectively toward a major engaging direction, wherein, an extension length of the major signal terminal engaging structure in the major engaging direction is a major signal terminal engaging structure extension length; an extension length of the first major ground terminal engaging structure in the major engaging direction is a first major ground terminal engaging structure extension length; and the first major ground terminal engaging structure extension length is greater than the major signal terminal engaging structure extension length, such that the first major ground terminal engaging structure provides shielding for the major signal terminal engaging structure.

Preferably, the electrical connector said above, further comprising: a minor conductive terminal set, one end of the minor conductive terminal set being a minor conductive terminal set engaging end, the minor conductive terminal set comprising a minor signal terminal and a first minor ground terminal, wherein the minor signal terminal and the first minor ground terminal respectively comprise a minor signal terminal engaging structure and a first minor ground terminal engaging structure at the minor conductive terminal set engaging end, and the minor signal terminal engaging structure and the first minor ground terminal engaging structure are extended respectively toward a minor engaging direction, wherein, an extension length of the minor signal terminal engaging structure in the minor engaging direction is a minor signal terminal engaging structure extension length; an extension length of the first minor ground terminal engaging structure in the minor engaging direction is a first minor ground terminal engaging structure extension length; and the first minor ground terminal engaging structure extension length is greater than the minor signal terminal engaging structure extension length, such that the first minor ground terminal engaging structure provides shielding for the minor signal terminal engaging structure; and a conductive metal connecting component disposed between the major conductive terminal set and the minor conductive terminal set, and electrically connected to the first major ground terminal and the first minor ground terminal respectively, so as to transmit a shielding signal and provide shielding for the major conductive terminal set and the minor conductive terminal set respectively.

Preferably, the electrical connector said above, wherein the major conductive terminal set further comprises a second major ground terminal, wherein, the second major ground terminal comprises a second major ground terminal engaging structure at the major conductive terminal set engaging end, wherein the second major ground terminal engaging structure is extended along the major engaging direction; an extension length of the second major ground terminal engaging structure in the major engaging direction is a second major ground terminal engaging structure extension length; and the major signal terminal is located between the first major ground terminal and the second major ground terminal, and the second major ground terminal engaging structure extension length is greater than the major signal terminal engaging structure extension length, such that the second major ground terminal engaging structure provides shielding for the major signal terminal engaging structure.

Preferably, the electrical connector said above, wherein the minor conductive terminal set further comprises a second minor ground terminal, wherein, the second minor ground terminal comprises a second minor ground terminal engaging structure at the minor conductive terminal set engaging end, wherein the second minor ground terminal engaging structure is extended along the minor engaging direction; an extension length of the second minor ground terminal engaging structure in the minor engaging direction is a second minor ground terminal engaging structure extension length; and the minor signal terminal is located between the first minor ground terminal and the second minor ground terminal, and the second minor ground terminal engaging structure extension length is greater than the minor signal terminal engaging structure extension length, such that the second minor ground terminal engaging structure provides shielding for the minor signal terminal engaging structure.

Preferably, the electrical connector said above further comprising: a major conductive plastic connecting subcomponent electrically connected to the first major ground terminal, the second major ground terminal, and the conductive metal connecting component respectively, so as to transmit the shielding signal; and a minor conductive plastic connecting subcomponent electrically connected to the first minor ground terminal, the second minor ground terminal, and the conductive metal connecting component respectively, so as to transmit the shielding signal.

Preferably, the electrical connector said above, further comprising a conductive plastic connecting component, wherein the first major ground terminal, the second major ground terminal, the first minor ground terminal, and the second minor ground terminal respectively abut the conductive plastic connecting component, and the conductive metal connecting component is inserted into the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

Preferably, the electrical connector said above, further comprising a conductive plastic connecting component, wherein the first major ground terminal, the second major ground terminal, the first minor ground terminal, and the second minor ground terminal are respectively inserted into the conductive plastic connecting component, and the conductive metal connecting component abuts the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

Preferably, the electrical connector said above, wherein another end of the major conductive terminal set is a major conductive terminal set joining end, and the major signal terminal comprises a major signal terminal joining structure at the major conductive terminal set joining end, wherein the conductive metal connecting component is extended from the major conductive terminal set engaging end to the major conductive terminal set joining end so as to provide shielding for the major signal terminal engaging structure and the major signal terminal joining structure respectively; and another end of the minor conductive terminal set is a minor conductive terminal set joining end, and the minor signal terminal comprises a minor signal terminal joining structure at the minor conductive terminal set joining end, wherein the conductive metal connecting component is extended from the minor conductive terminal set engaging end to the minor conductive terminal set joining end so as to provide shielding for the minor signal terminal engaging structure and the minor signal terminal joining structure respectively.

Preferably, the electrical connector said above further comprising a first ground terminal connecting member and a second ground terminal connecting member, the first ground terminal connecting member being electrically connected to the first major ground terminal and the first minor ground terminal, the second ground terminal connecting member being electrically connected to the second major ground terminal and the second minor ground terminal, wherein the conductive metal connecting component comprises a first connecting member passage and a second connecting member passage, wherein the first ground terminal connecting member passes through the first connecting member passage and is electrically connected to the conductive metal connecting component, and the second ground terminal connecting member passes through the second connecting member passage and is electrically connected to the conductive metal connecting component.

Preferably, the electrical connector said above, wherein the first major ground terminal, the second major ground terminal, the first minor ground terminal, and the second minor ground terminal respectively abut the conductive metal connecting component, such that the first major ground terminal, the second major ground terminal, the first minor ground terminal, and the second minor ground terminal are respectively electrically connected to the conductive metal connecting component.

Furthermore, the present application provides a conductive component module. The conductive component module comprises: an engaging conductive component; a joining conductive component; and the aforementioned electrical connector. The major signal terminal engaging structure, the first major grounding terminal engaging structure, the second major grounding terminal engaging structure, the minor signal terminal engaging structure, the first minor grounding terminal engaging structure, and the second minor grounding terminal engaging structure are provided to engage the engaging conductive component. The major signal terminal joining structure, the first major grounding terminal joining structure, the second major grounding terminal joining structure, the minor signal terminal joining structure, the first minor grounding terminal joining structure, and the second minor grounding terminal joining structure are provided to join the joining conductive component.

Preferably, the conductive component module said above, the engaging conductive component is an engaging connector or an engaging plate, and the joining conductive component is a joining plate or a joining cable.

Additionally, the present application provides an electrical connector comprising: a major conductive terminal set, one end of the major conductive terminal set being a major conductive terminal set engaging end, the major conductive terminal set comprising a major signal terminal, a first major ground terminal, and a second major ground terminal which respectively comprise a major signal terminal engaging structure, a first major ground terminal engaging structure, and a second major ground terminal engaging structure at the major conductive terminal set engaging end, wherein, the first major ground terminal engaging structure and the second major ground terminal engaging structure are respectively located at two opposite sides of the major signal terminal engaging structure, such that the first major ground terminal engaging structure and the second major ground terminal engaging structure provide a major engaging structure shielding environment for the major signal terminal engaging structure, and the first major ground terminal and the second major ground terminal are respectively taller than the major signal terminal, such that the major signal terminal is located within the major engaging structure shielding environment.

Preferably, the electrical connector said above further comprising: a minor conductive terminal set, one end of the minor conductive terminal set being a minor conductive terminal set engaging end, the minor conductive terminal set comprising a minor signal terminal, a first minor ground terminal, and a second minor ground terminal which respectively comprise a minor signal terminal engaging structure, a first minor ground terminal engaging structure, and a second minor ground terminal engaging structure at the minor conductive terminal set engaging end, wherein, the first minor ground terminal engaging structure and the second minor ground terminal engaging structure are respectively located at two opposite sides of the minor signal terminal engaging structure, such that the first minor ground terminal engaging structure and the second minor ground terminal engaging structure provide a minor engaging structure shielding environment for the minor signal terminal engaging structure, and the first minor ground terminal and the second minor ground terminal are respectively taller than the minor signal terminal, such that the minor signal terminal is located within the minor engaging structure shielding environment; and a conductive metal connecting component disposed between the major conductive terminal set and the minor conductive terminal set. and electrically connected to the first major ground terminal, the second major ground terminal, the first minor ground terminal, and the second minor ground terminal respectively, so as to transmit a shielding signal and provide shielding for the major conductive terminal set and the minor conductive terminal set respectively.

Preferably, the electrical connector said above, further comprising: a major conductive plastic connecting subcomponent electrically connected to the first major ground terminal, the second major ground terminal, and the conductive metal connecting component respectively, so as to transmit the shielding signal; and a minor conductive plastic connecting subcomponent electrically connected to the first minor ground terminal, the second minor ground terminal, and the conductive metal connecting component, so as to transmit the shielding signal.

Preferably, the electrical connector said above further comprising a conductive plastic connecting component, wherein the first major ground terminal, the second major ground terminal, the first minor ground terminal, and the second minor ground terminal respectively abut the conductive plastic connecting component, and the conductive metal connecting component is inserted into the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

Preferably, the electrical connector said above further comprising a conductive plastic connecting component, wherein the first major ground terminal, the second major ground terminal, the first minor ground terminal, and the second minor ground terminal are respectively inserted into the conductive plastic connecting component, and the conductive metal connecting component abuts the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

Preferably, the electrical connector said above, wherein another end of the major conductive terminal set is a major conductive terminal set joining end, and the major signal terminal comprises a major signal terminal joining structure at the major conductive terminal set joining end, wherein the conductive metal connecting component is extended from the major conductive terminal set engaging end to the major conductive terminal set joining end so as to provide shielding for the major signal terminal engaging structure and the major signal terminal joining structure respectively; and another end of the minor conductive terminal set is a minor conductive terminal set joining end, and the minor signal terminal comprises a minor signal terminal joining structure at the minor conductive terminal set joining end, wherein the conductive metal connecting component is extended from the minor conductive terminal set engaging end to the minor conductive terminal set joining end so as to provide shielding for the minor signal terminal engaging structure and the minor signal terminal joining structure respectively.

Preferably, the electrical connector said above, wherein the electrical connector further comprises a first ground terminal connecting member and a second ground terminal connecting member, the first ground terminal connecting member being electrically connected to the first major ground terminal and the first minor ground terminal, the second ground terminal connecting member being electrically connected to the second major ground terminal and the second minor ground terminal, wherein the conductive metal connecting component comprises a first connecting member passage and a second connecting member passage, wherein the first ground terminal connecting member passes through the first connecting member passage and is electrically connected to the conductive metal connecting component, and the second ground terminal connecting member passes through the second connecting member passage and is electrically connected to the conductive metal connecting component.

Preferably, the electrical connector said above, wherein the first major ground terminal, the second major ground terminal, the first minor ground terminal, and the second minor ground terminal respectively abut the conductive metal connecting component, such that the first major ground terminal, the second major ground terminal, the first minor ground terminal, and the second minor ground terminal are respectively electrically connected to the conductive metal connecting component.

Furthermore, the present application provides a conductive component module. The conductive component module comprises: an engaging conductive component; a joining conductive component; and the aforementioned electrical connector. The major signal terminal engaging structure, the first major grounding terminal engaging structure, the second major grounding terminal engaging structure, the minor signal terminal engaging structure, the first minor grounding terminal engaging structure, and the second minor grounding terminal engaging structure are provided to engage the engaging conductive component. The major signal terminal joining structure, the first major grounding terminal joining structure, the second major grounding terminal joining structure, the minor signal terminal joining structure, the first minor grounding terminal joining structure, and the second minor grounding terminal joining structure are provided to join the joining conductive component.

Preferably, the conductive component module said above, the engaging conductive component is an engaging connector or an engaging plate, and the joining conductive component is a joining plate or a joining cable.

Compared with the prior art, the present application provides a conductive component module and an electrical connector thereof. The conductive component module comprises: an engaging conductive component, a joining conductive component, and an electrical connector. The electrical connector includes a conductive terminal set, which is configured to engage the engaging conductive component for signal transmission, and is further configured to join the joining conductive component for signal transmission. The conductive terminal set comprises a grounding terminal and a signal terminal. The grounding terminal is configured to provide shielding for the signal terminal to reduce interference in signal transmission of the signal terminal, thereby satisfying the signal transmission requirements of the electrical connector.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of the conductive component module of the present application according to one embodiment.

FIG. 2 is a perspective schematic view of the electrical connector of the present application from a first viewing angle according to one embodiment.

FIG. 3 is a perspective schematic view of the electrical connector of the present application from a second viewing angle according to one embodiment.

FIG. 4 is a perspective schematic view of the major conductive terminal set of the present application according to one embodiment.

FIG. 5 is a perspective schematic view of the minor conductive terminal set of the present application according to one embodiment.

FIG. 6 is a top schematic view of the electrical connector of the present application according to one embodiment.

FIG. 7 is a cross sectional schematic view taken along line AA of a partial component of the electrical connector shown in FIG. 6.

FIG. 8 is a cross sectional schematic view taken along line BB of a partial component of the electrical connector shown in FIG. 6.

FIG. 9 is a rear schematic view of the electrical connector of the present application according to one embodiment.

FIG. 10 is a perspective schematic view of the electrical connector of the present application according to one embodiment.

FIG. 11 is a rear schematic view of the conductive terminal set of the present application according to one embodiment.

FIG. 12 is a rear schematic view of the conductive terminal set of the present application according to one embodiment.

FIG. 13 is a side schematic view of the conductive terminal set of the present application according to one embodiment.

FIG. 14 is a perspective schematic view of a partial component of the electrical connector of the present application from a first viewing angle according to one embodiment.

FIG. 15 is a perspective schematic view of a partial component of the electrical connector of the present application from a second viewing angle according to one embodiment.

FIG. 16 is a perspective schematic view of the electrical connector of the present application from a second viewing angle according to one embodiment.

FIG. 17 is a perspective schematic view of a partial component of the electrical connector of the present application according to one embodiment.

FIG. 18 is a top schematic view of the electrical connector of the present application according to one embodiment.

FIG. 19 is a cross sectional schematic view taken along line CC of a partial component of the electrical connector shown in FIG. 18.

FIG. 20 is a cross sectional schematic view of the electrical connector of the present application according to one embodiment.

FIG. 21 is a side schematic view of the conductive terminal set of the present application according to one embodiment.

FIG. 22 is a perspective schematic view of the electrical connector of the present application according to one embodiment.

FIG. 23 is a perspective schematic view of the conductive terminal set of the present application according to one embodiment.

FIG. 24 is a perspective schematic view of the electrical connector of the present application from a first viewing angle according to one embodiment.

FIG. 25 is a perspective schematic view of the electrical connector of the present application from a second viewing angle according to one embodiment.

FIG. 26 is a top schematic view of the electrical connector of the present application according to one embodiment.

FIG. 27 is a cross sectional schematic view taken along line DD of a partial component of the electrical connector shown in FIG. 26.

FIG. 28 is a cross sectional schematic view taken along line EE of a partial component of the electrical connector shown in FIG. 26.

FIG. 29 is a cross sectional schematic view of a partial component of the electrical connector of the present application according to one embodiment.

FIG. 30 is a perspective schematic view of the electrical connector of the present application according to one embodiment.

FIG. 31 is a perspective schematic view of the electrical connector of the present application according to one embodiment.

FIG. 32 is a perspective schematic view of the electrical connector of the present application from a first viewing angle according to one embodiment.

FIG. 33 is a perspective schematic view of the electrical connector of the present application from a second viewing angle according to one embodiment.

FIG. 34 is a top schematic view of the electrical connector of the present application according to one embodiment.

FIG. 35 is a cross sectional schematic view taken along line FF of a partial component of the electrical connector shown in FIG. 34.

FIG. 36 is a cross sectional schematic view taken along line GG of a partial component of the electrical connector shown in FIG. 34.

FIG. 37 is a perspective schematic view of the electrical connector of the present application according to one embodiment.

FIG. 38 is a perspective schematic view of the electrical connector of the present application according to one embodiment.

FIG. 39 is a top schematic view of the electrical connector of the present application according to one embodiment.

FIG. 40 is a cross sectional schematic view taken along line HH of a partial component of the electrical connector shown in FIG. 39.

FIG. 41 is a cross sectional schematic view taken along line II of a partial component of the electrical connector shown in FIG. 39.

FIG. 42 is a perspective schematic view of a partial component of the electrical connector of the present application according to one embodiment.

FIG. 43 is a perspective schematic view of the electrical connector of the present application according to one embodiment.

FIG. 44 is a top schematic view of the electrical connector of the present application according to one embodiment.

FIG. 45 is a cross sectional schematic view taken along line JJ of a partial component of the electrical connector shown in FIG. 44.

FIG. 46 is a cross sectional schematic view taken along line KK of a partial component of the electrical connector shown in FIG. 44.

FIG. 47 is a perspective schematic view of the electrical connector of the present application according to one embodiment.

FIG. 48 is a perspective schematic view of a partial component of the electrical connector of the present application according to one embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

It should also be noted that, for the purpose of presenting the disclosed content in a more concise and comprehensible manner, components comprising identical or similar functions in the following embodiments will be denoted by the same reference numerals, and descriptions of identical or equivalent features will be omitted.

The present application provides at least one conductive component module and its electrical connector, wherein the electrical connector comprises a ground terminal and a signal terminal, and the ground terminal is configured to provide shielding for the signal terminal to reduce the degree of interference with signal transmission of the signal terminal, thereby meeting the signal transmission requirement of the electrical connector.

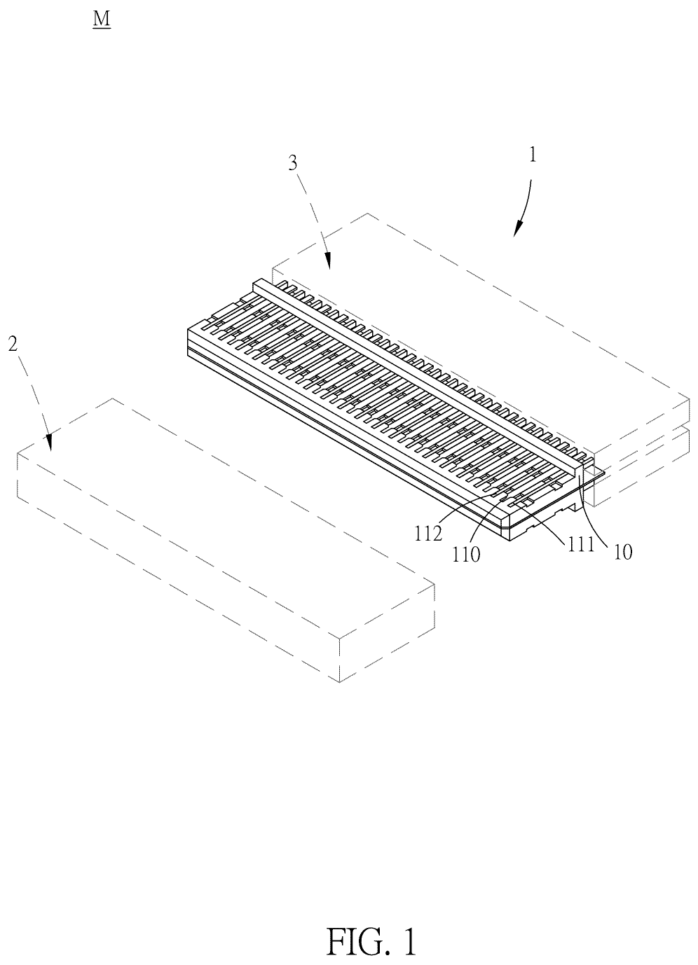

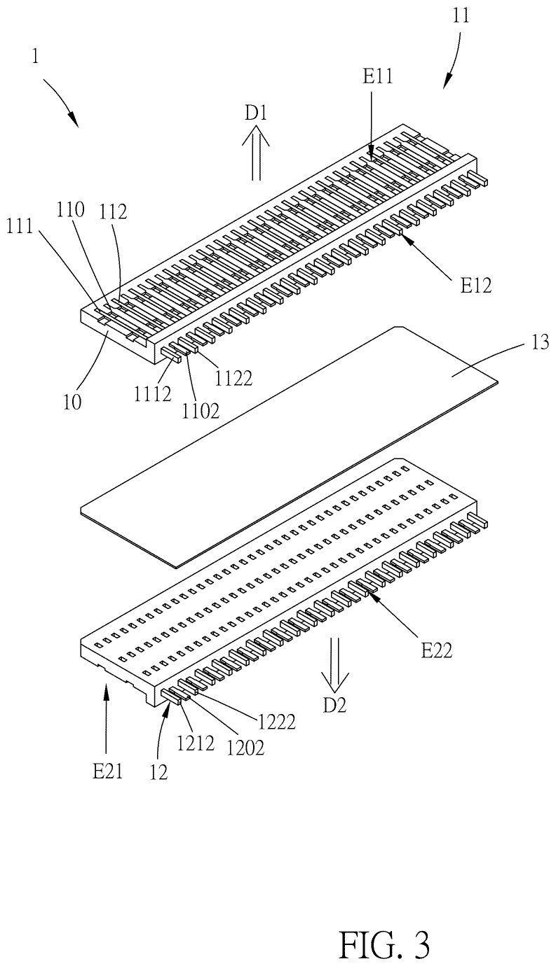

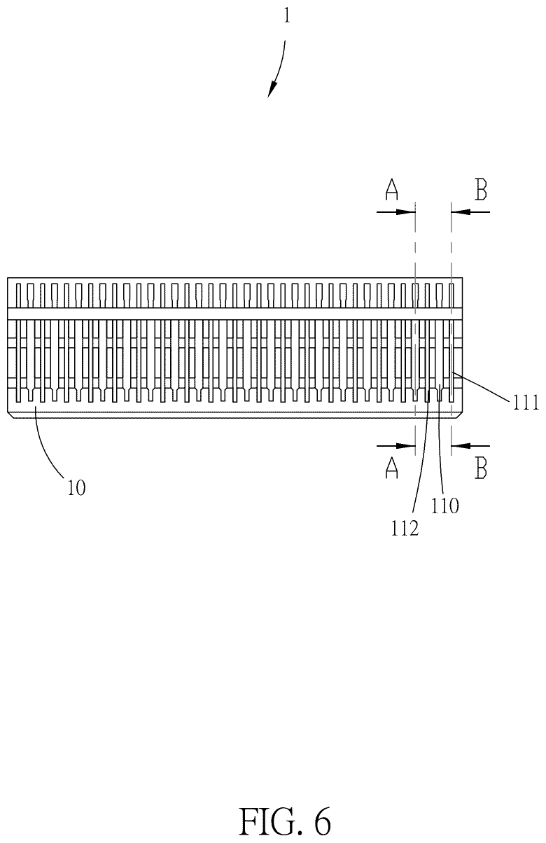

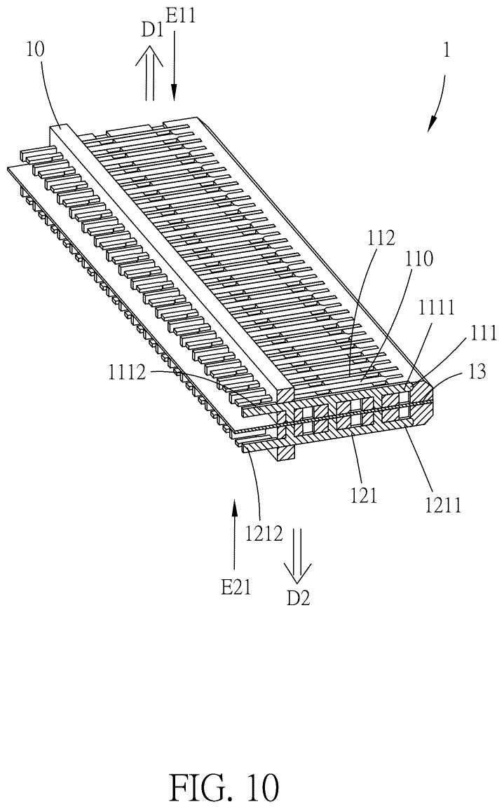

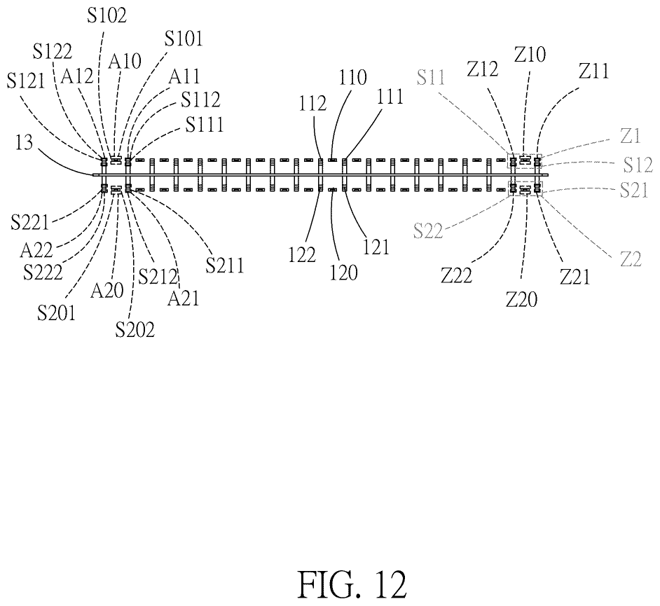

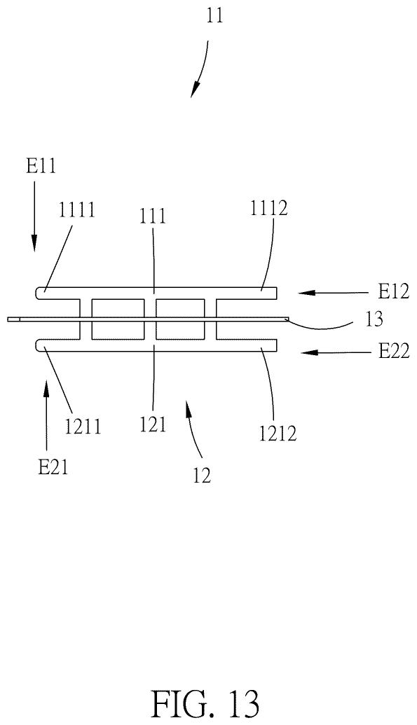

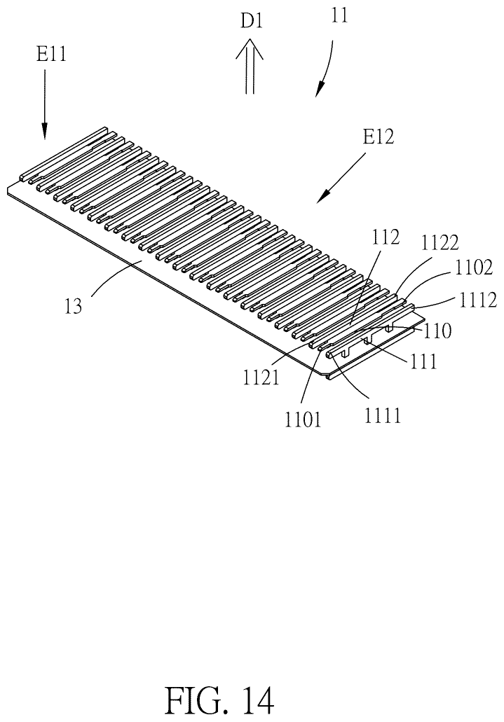

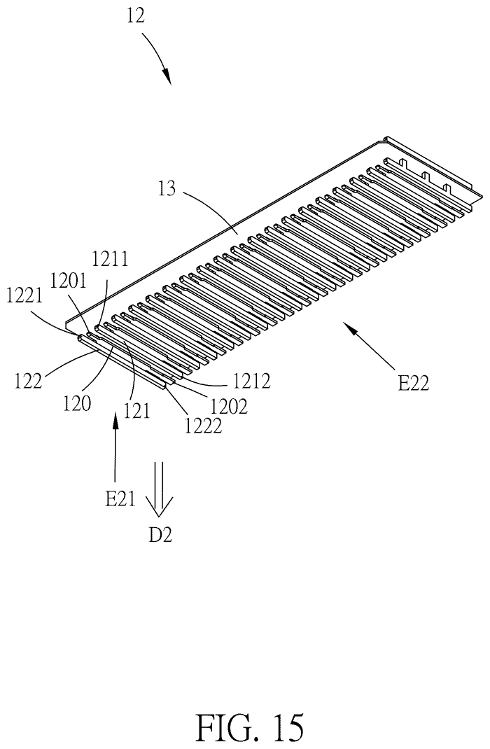

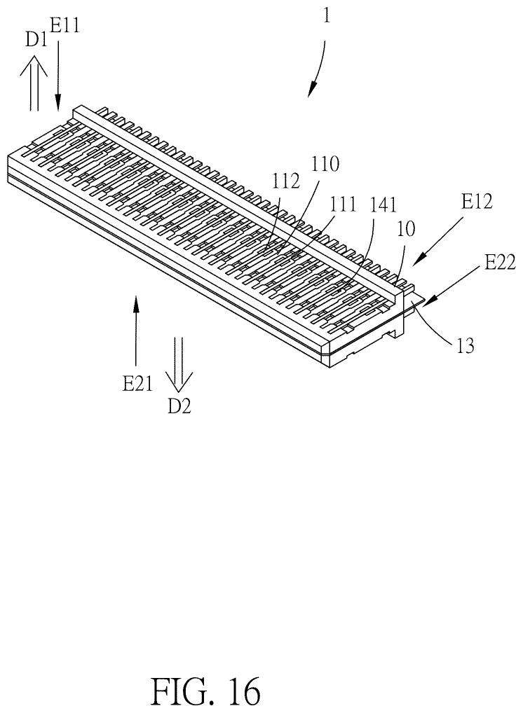

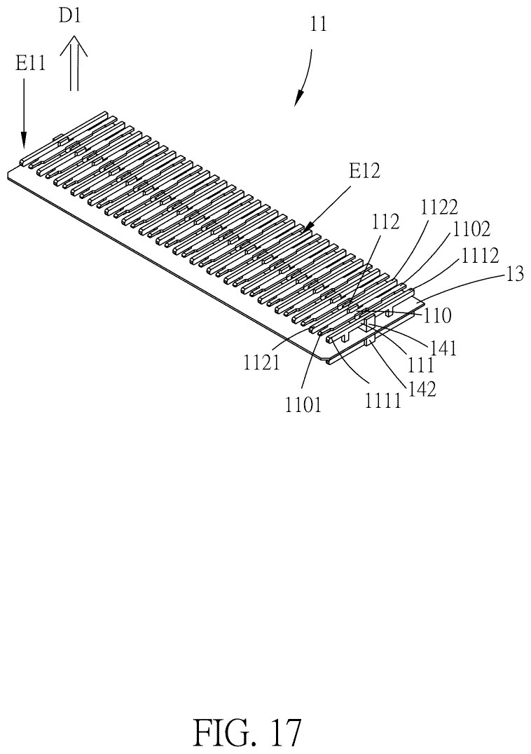

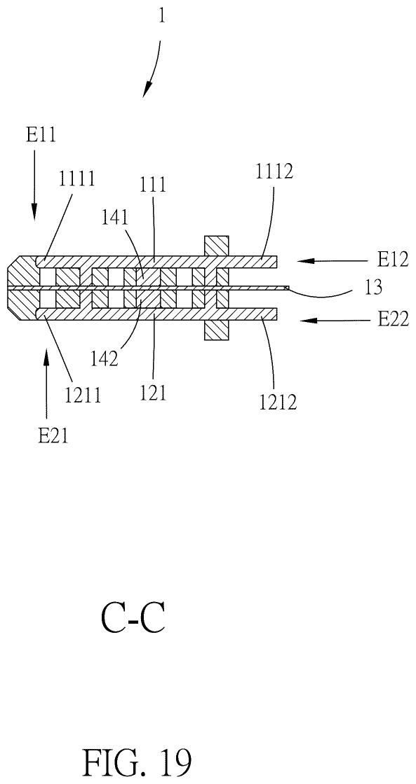

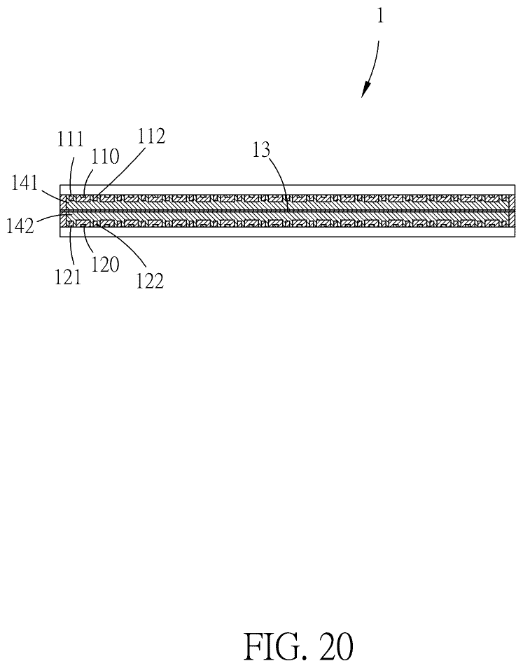

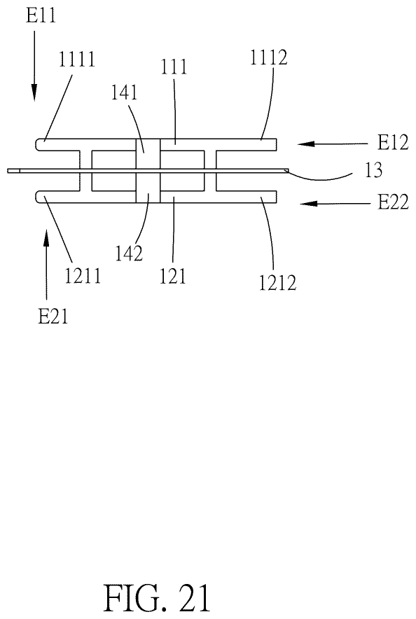

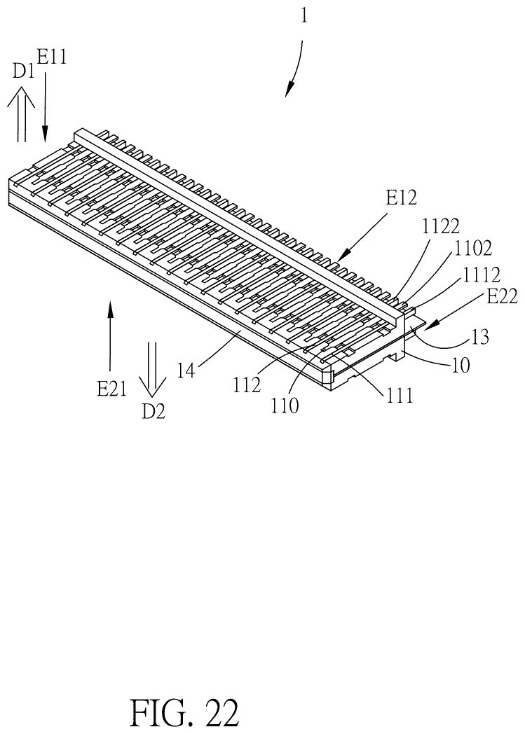

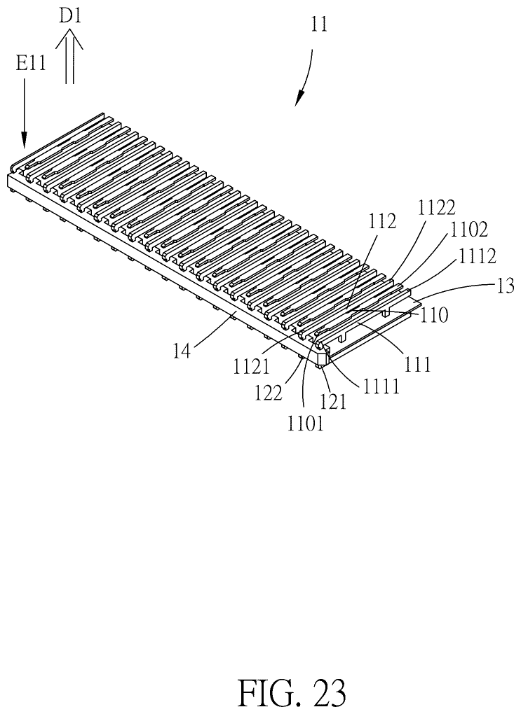

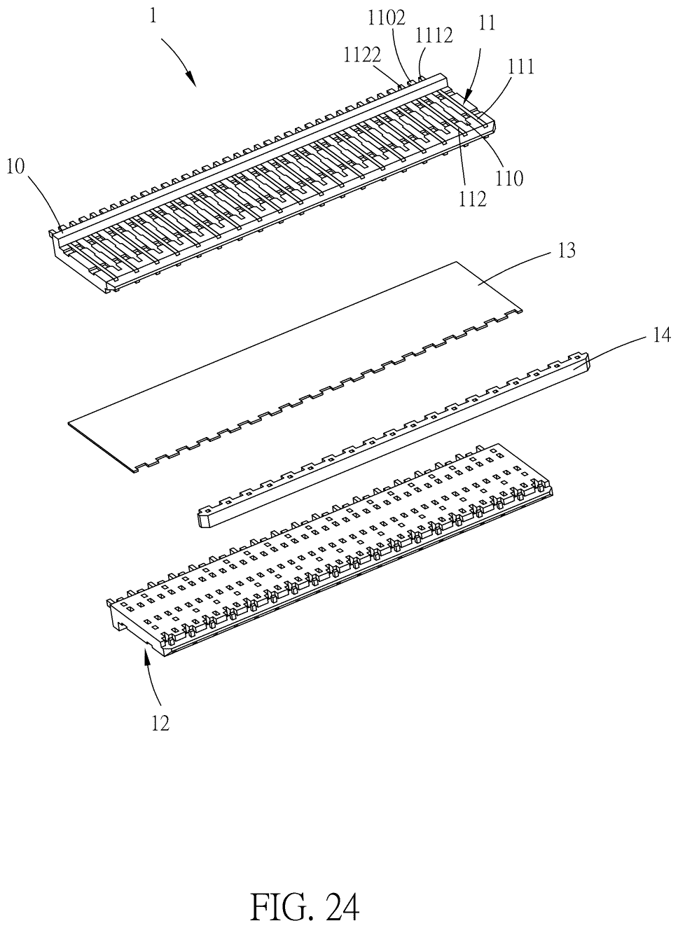

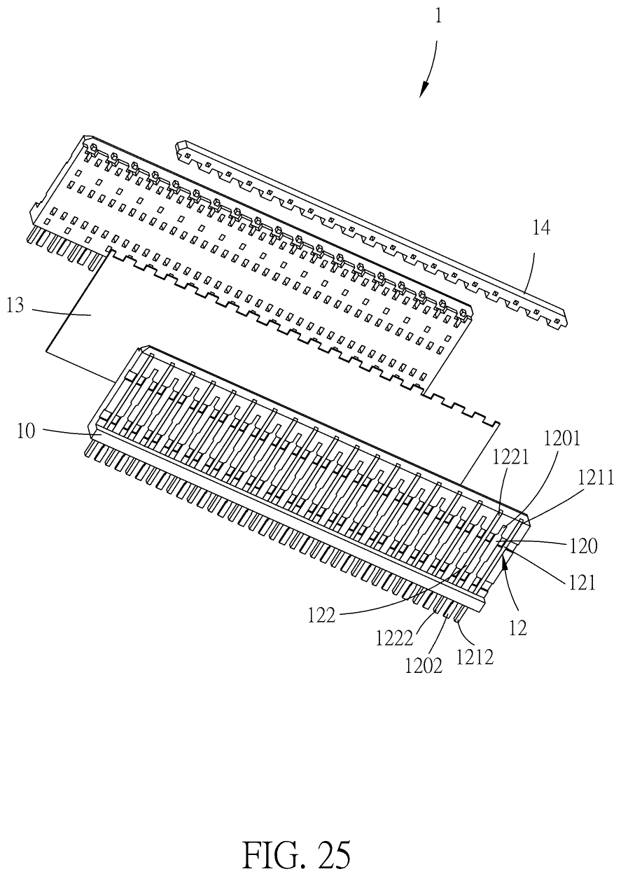

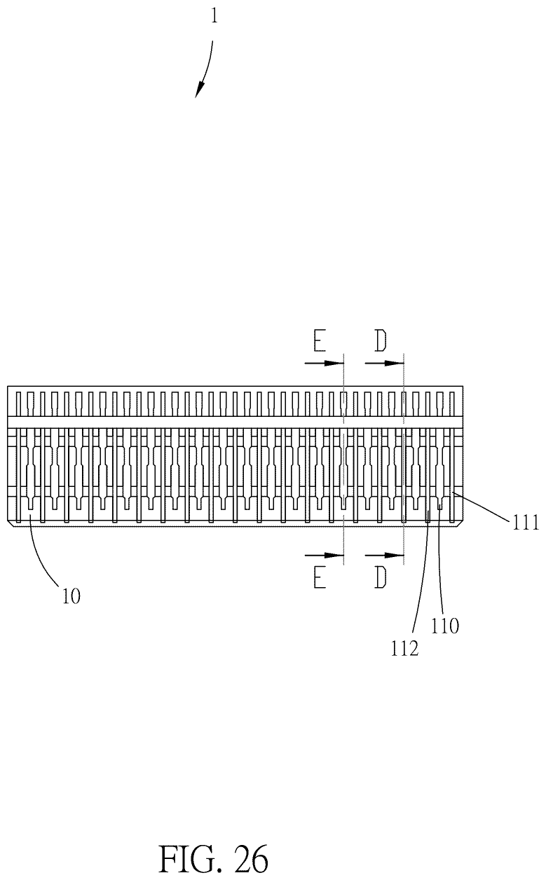

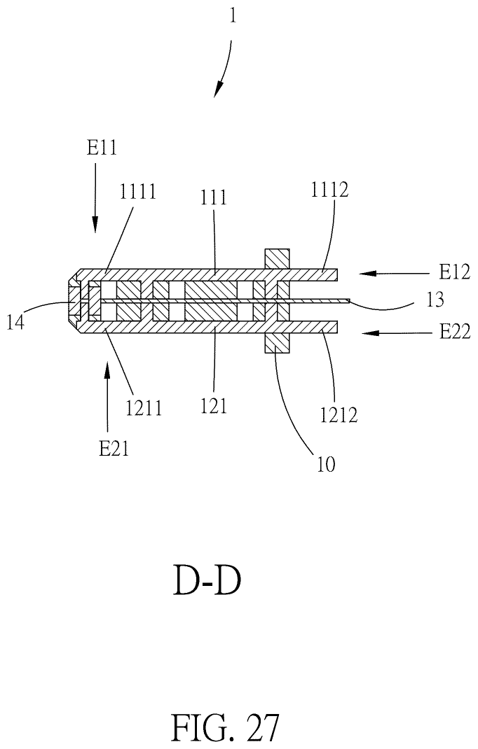

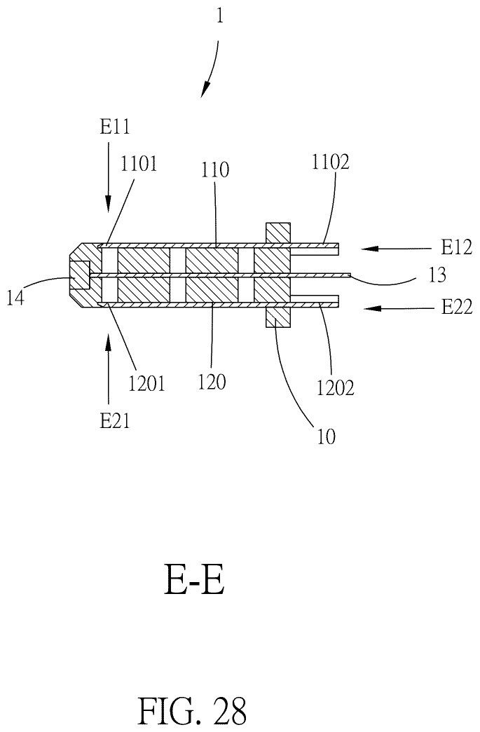

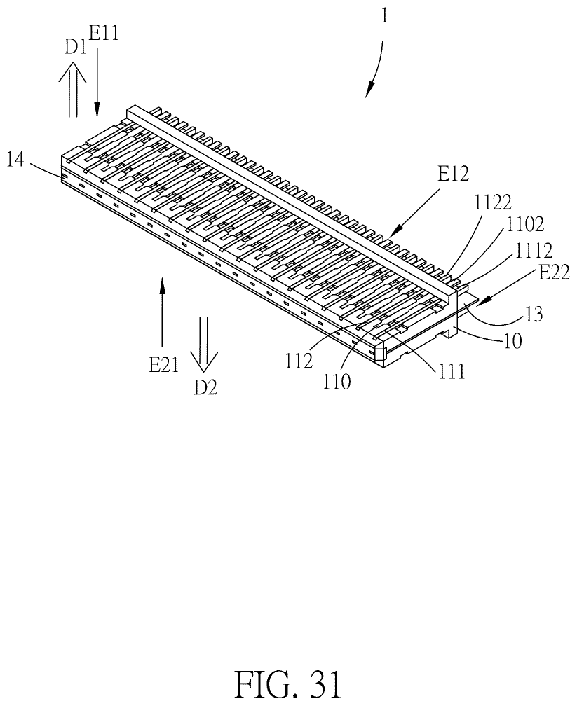

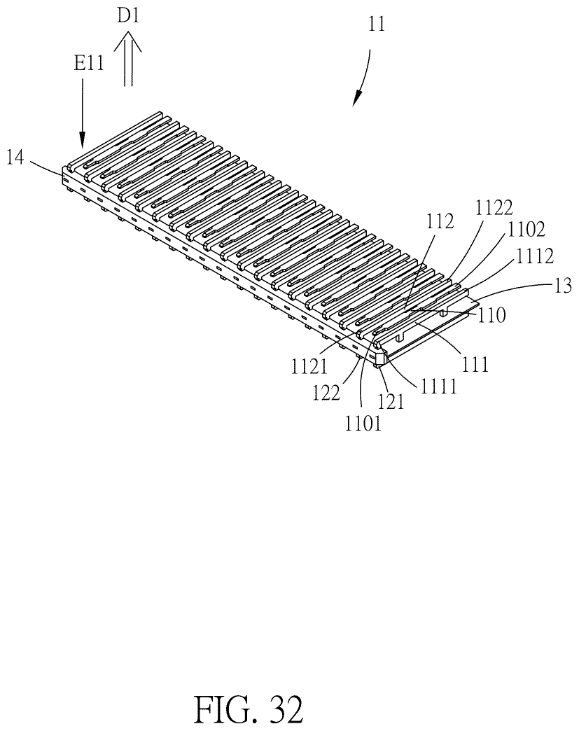

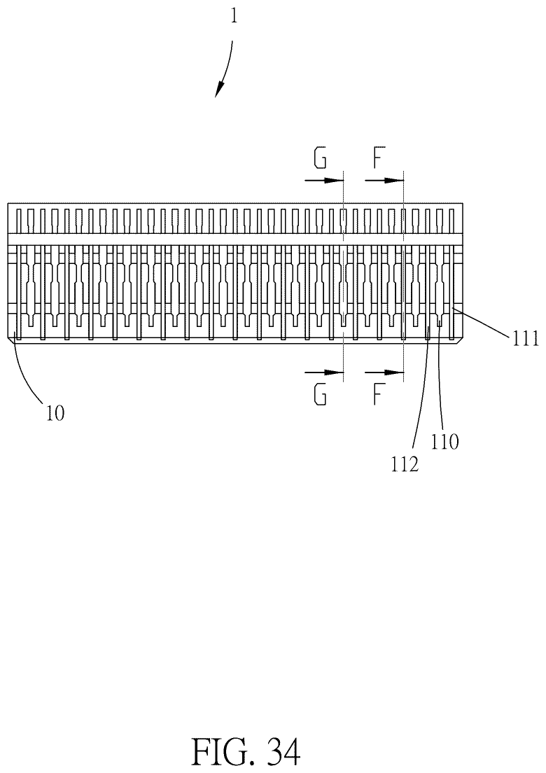

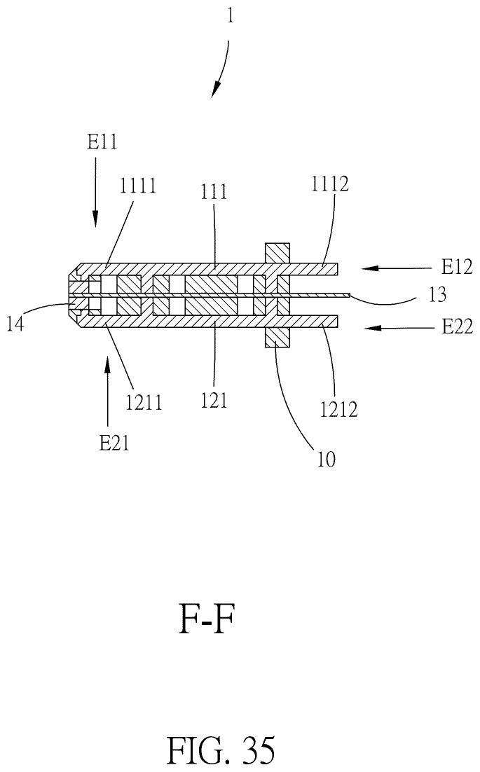

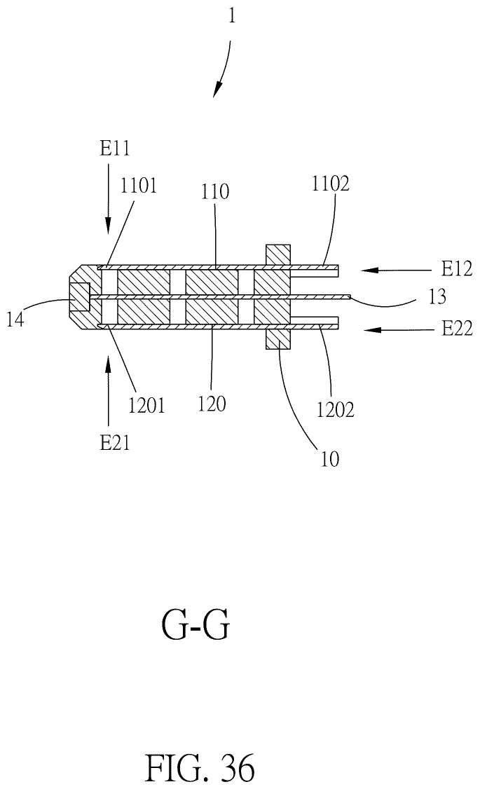

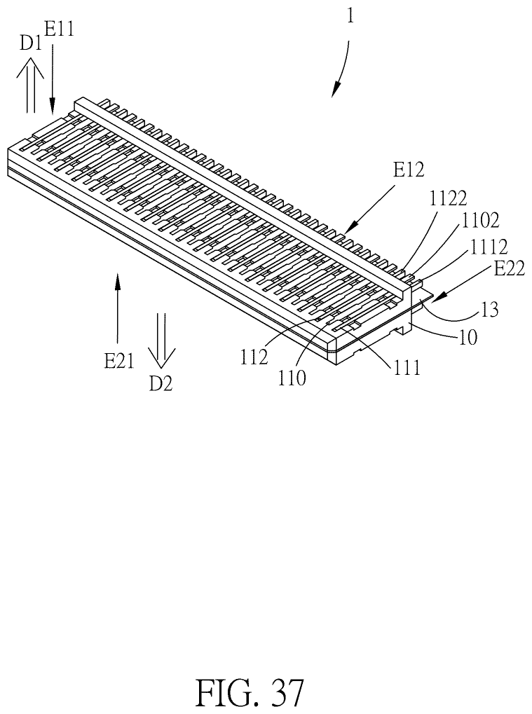

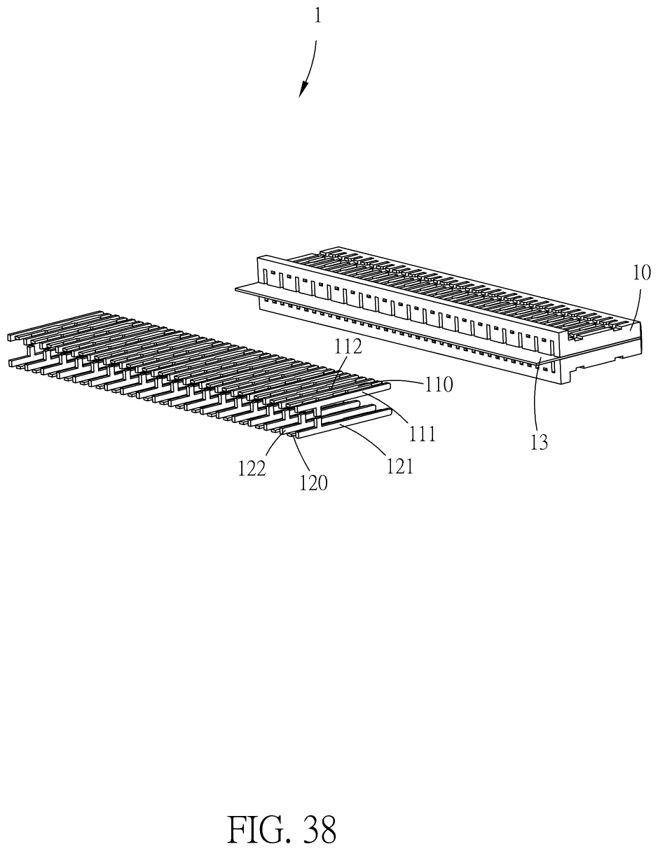

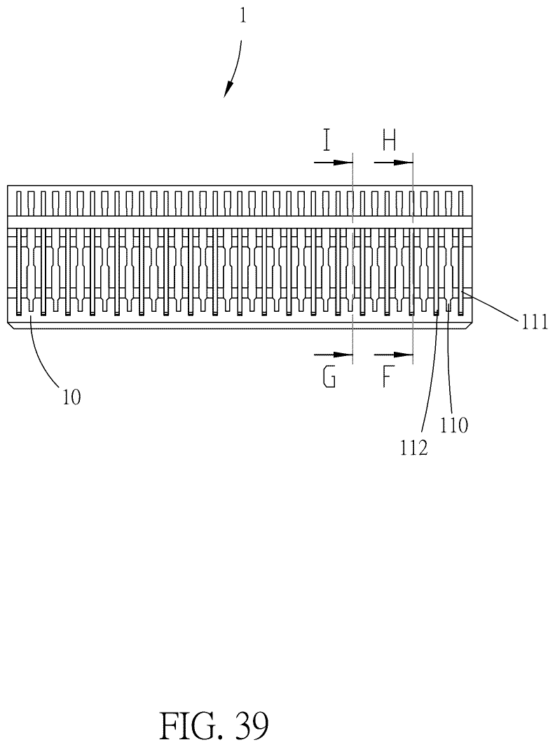

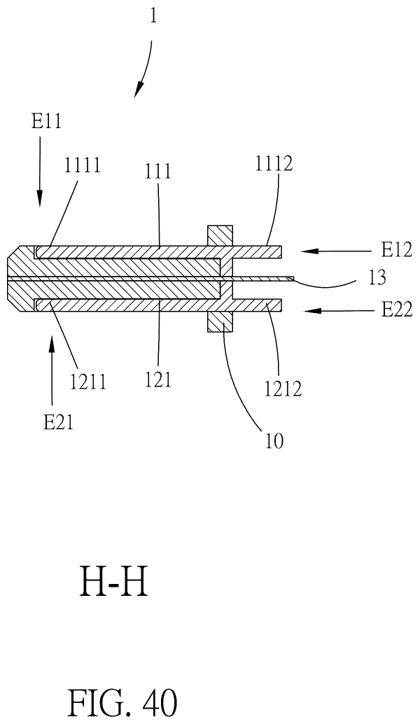

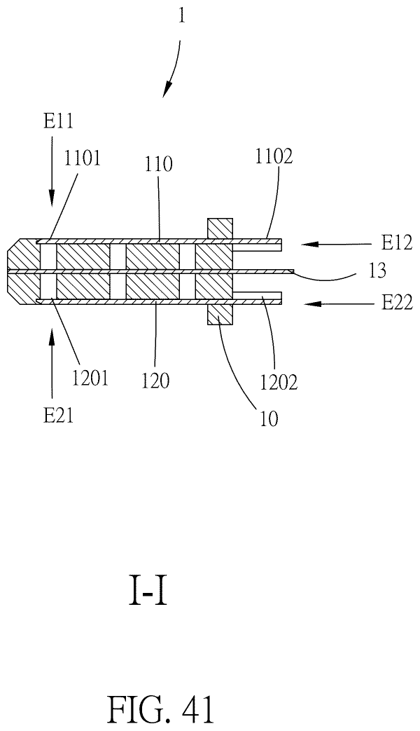

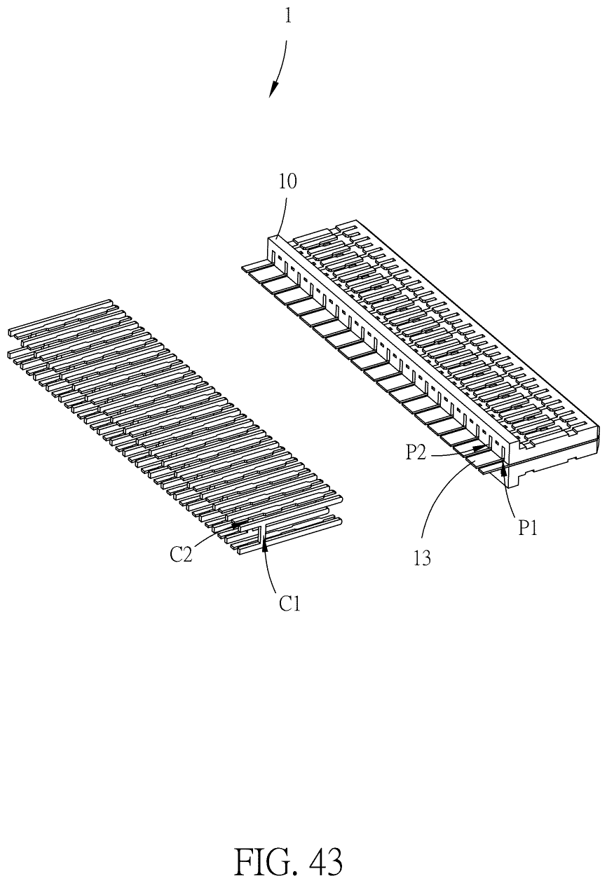

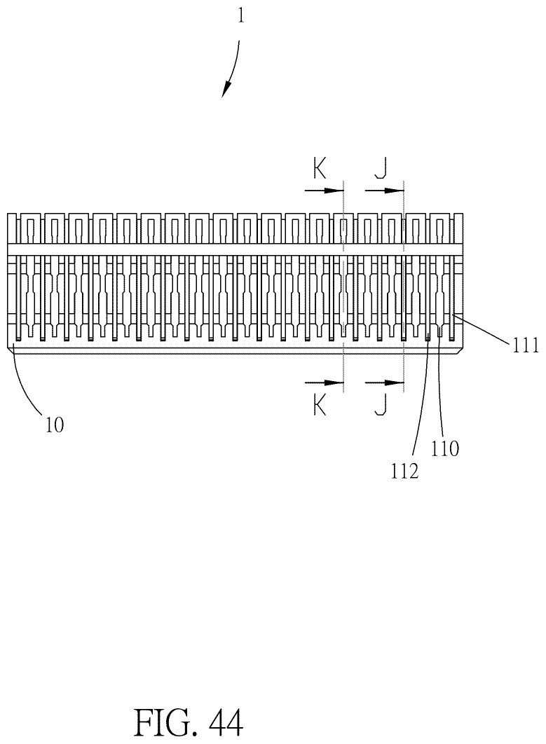

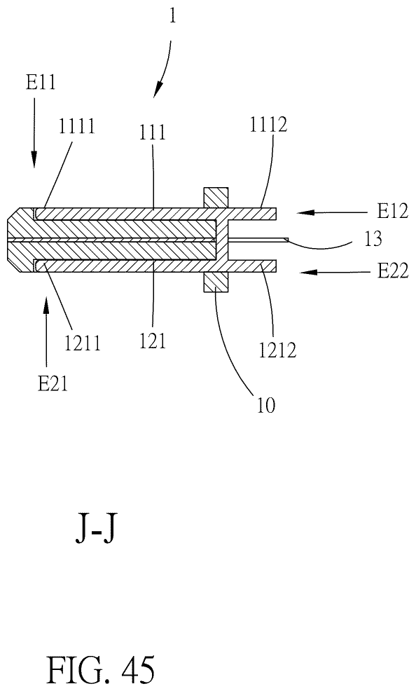

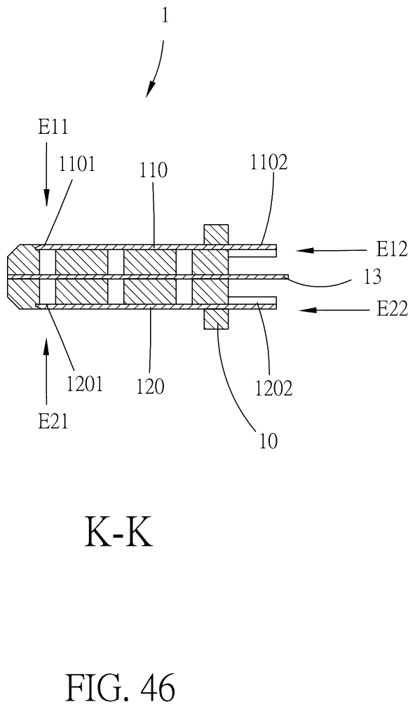

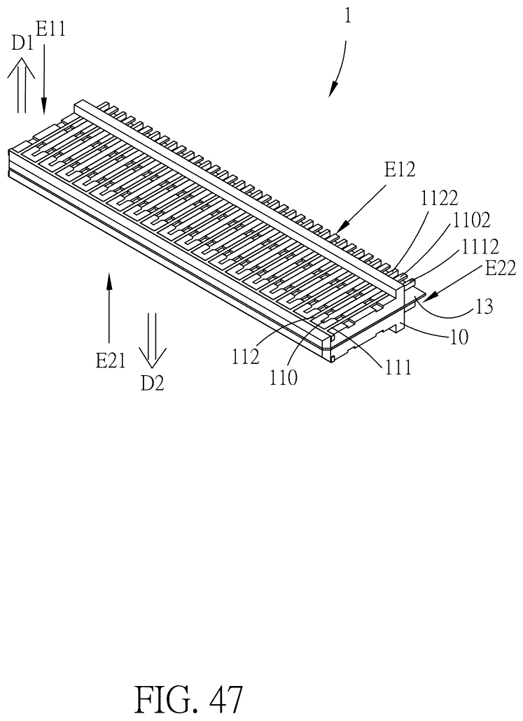

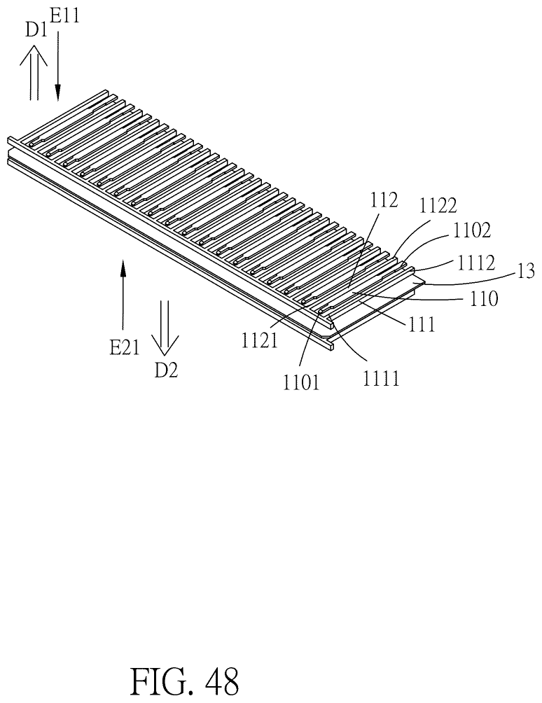

For a detailed description of the embodiments disclosed in the present application, please refer to FIGS. 1 to 48.

In the embodiments shown in FIGS. 1 to 48 of the present application, a conductive component module M is disclosed. The conductive component module M comprises: an electrical connector 1, an engaging conductive component 2, and a joining conductive component 3.

Regarding the engaging conductive component 2, the engaging conductive component 2 is, for example, a signal transmitting engaging connector or engaging plate. The joining conductive component 3 is, for example, a signal transmitting joining plate or joining cable.

The electrical connector 1 comprises: an electrical connector body 10, a major conductive terminal set 11, a minor conductive terminal set 12, a conductive metal connecting component 13, and a conductive plastic connecting component 14.

Regarding the electrical connector body 10, the electrical connector body 10 is optionally made of insulating material and comprises a major terminal engaging structure arrangement region Z1 and a minor terminal engaging structure arrangement region Z2. The major terminal engaging structure arrangement region Z1 is, for example, a rectangular region, and comprises a major terminal engaging structure arrangement region long side S11 and a major terminal engaging structure arrangement region short side S12. The major terminal engaging structure arrangement region long side S11 and the major terminal engaging structure arrangement region short side S12 are respectively located at the long side and the short end side of the major terminal engaging structure arrangement region Z1. The minor terminal engaging structure arrangement region Z2 is, for example, a rectangular region, and comprises a minor terminal engaging structure arrangement region long side S21 and a minor terminal engaging structure arrangement region short side S22. The minor terminal engaging structure arrangement region long side S21 and the minor terminal engaging structure arrangement region short side S22 are respectively located at the long side and the short end side of the minor terminal engaging structure arrangement region Z2.

Regarding the major conductive terminal set 11, the two ends of the major conductive terminal set 11 are respectively a major conductive terminal set engaging end E11 and a major conductive terminal set joining end E12.

The major conductive terminal set 11 comprises a major signal terminal 110, a first major ground terminal 111, and a second major ground terminal 112. The first major ground terminal 111 and the second major ground terminal 112 are configured to transmit ground signals, wherein the ground signal in the above embodiment is a shielding signal. The major signal terminal 110, the first major ground terminal 111, and the second major ground terminal 112 respectively have a major signal terminal engaging structure 1101, a first major ground terminal engaging structure 1111, and a second major ground terminal engaging structure 1121 at the major conductive terminal set engaging end E11. The major signal terminal engaging structure 1101, the first major ground terminal engaging structure 1111, and the second major ground terminal engaging structure 1121 are respectively arranged in the major terminal engaging structure arrangement region Z1 and extended toward a major engaging direction D1 to engage the engaging conductive component 2.

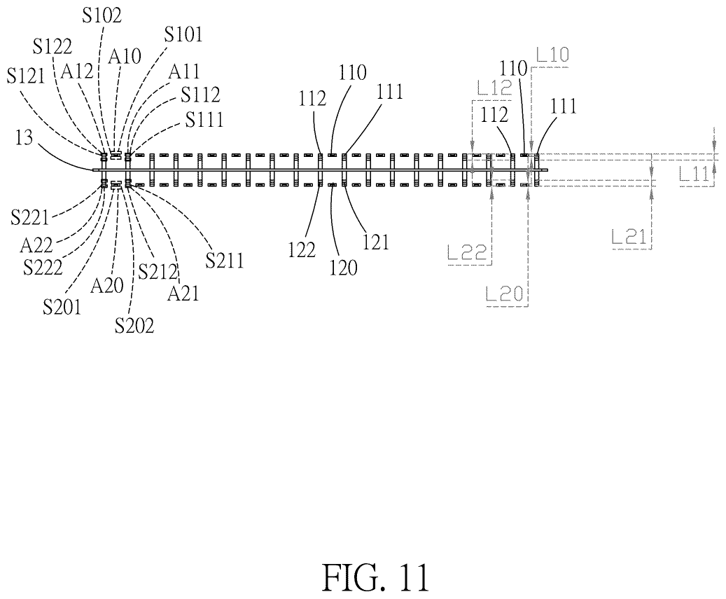

In the embodiment shown in FIG. 11, the extension length of the major signal terminal engaging structure 1101 in the major engaging direction D1 is a major signal terminal engaging structure extension length L10. The extension length of the first major ground terminal engaging structure 1111 in the major engaging direction D1 is a first major ground terminal engaging structure extension length L11. The extension length of the second major ground terminal engaging structure 1121 in the major engaging direction D1 is a second major ground terminal engaging structure extension length L12.

It should be noted that the first major ground terminal engaging structure extension length L11 is greater than the major signal terminal engaging structure extension length L10, such that the first major ground terminal engaging structure 1111 can provide shielding for the major signal terminal engaging structure 1101 to reduce the degree of interference with signal transmission of the major signal terminal engaging structure 1101, thereby meeting the signal transmission requirement of the electrical connector 1. The second major ground terminal engaging structure extension length L12 is greater than the major signal terminal engaging structure extension length L10, such that the second major ground terminal engaging structure 1121 can provide shielding for the major signal terminal engaging structure 1101 to reduce the degree of interference with signal transmission of the major signal terminal engaging structure 1101, thereby meeting the signal transmission requirement of the electrical connector 1.

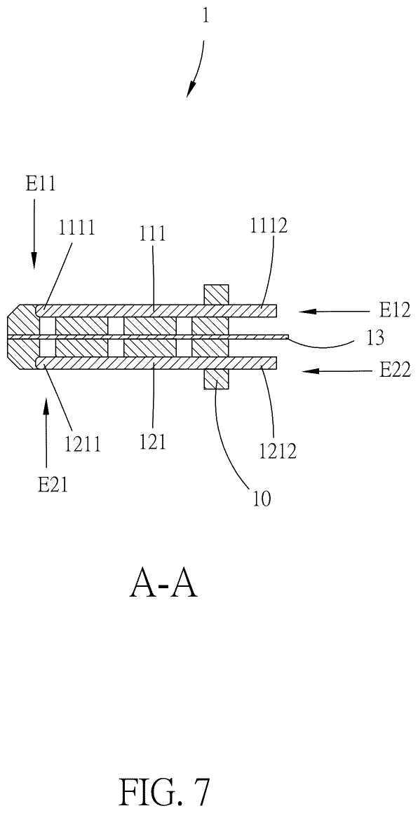

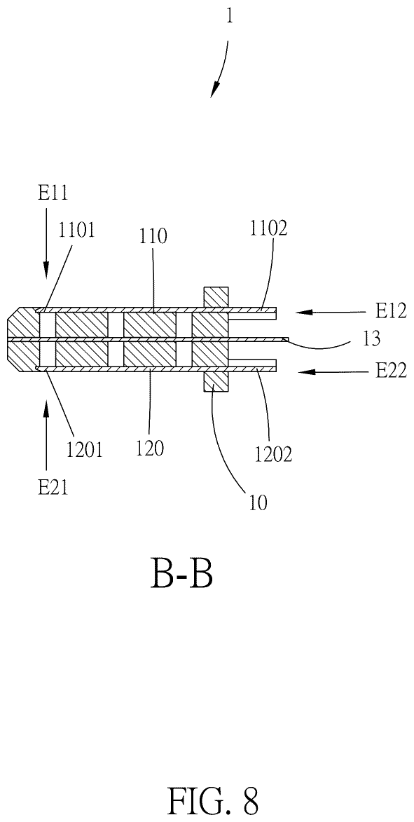

Additionally, the major signal terminal 110, the first major ground terminal 111, and the second major ground terminal 112 respectively comprise a major signal terminal joining structure 1102, a first major ground terminal joining structure 1112, and a second major ground terminal joining structure 1122 at the major conductive terminal set joining end E12. The major signal terminal joining structure 1102, the first major ground terminal joining structure 1112, and the second major ground terminal joining structure 1122 are configured to join the joining conductive component 3, wherein the major signal terminal joining structure 1102 is positioned between the first major ground terminal joining structure 1112 and the second major ground terminal joining structure 1122. In the embodiments shown in FIGS. 7 to 8, the conductive metal connecting component 13 is extended from the major conductive terminal set engaging end E11 to the major conductive terminal set joining end E12 to provide shielding for the major signal terminal engaging structure 1101 and the major signal terminal joining structure 1102, thereby reducing the degree of interference with signal transmission of the major signal terminal engaging structure 1101 and the major signal terminal joining structure 1102, and satisfying the signal transmission requirement of the electrical connector 1.

In the above embodiment, the cross section of the major signal terminal engaging structure 1101 in the major terminal engaging structure arrangement region Z1 is a major signal terminal engaging structure cross section A10, which is a rectangular cross section and comprises a major signal terminal engaging structure cross section long side S101 and a major signal terminal engaging structure cross section short side S102. The major signal terminal engaging structure cross section long side S101 and the major signal terminal engaging structure cross section short side S102 are respectively located at the long side and the short side of the major signal terminal engaging structure cross section A10.

In addition, the cross section of the first major ground terminal engaging structure 1111 in the major terminal engaging structure arrangement region Z1 is a first major ground terminal engaging structure cross section A11, which is a rectangular cross section and comprises a first major ground terminal engaging structure cross section long side S111 and a first major ground terminal engaging structure cross section short side S112. The first major ground terminal engaging structure cross section long side S111 and the first major ground terminal engaging structure cross section short side S112 are respectively located at the long side and the short side of the first major ground terminal engaging structure cross section A11.

Furthermore, the cross section of the second major ground terminal engaging structure 1121 in the major terminal engaging structure arrangement region Z1 is a second major ground terminal engaging structure cross section A12, which is a rectangular cross section and comprises a second major ground terminal engaging structure cross section long side S121 and a second major ground terminal engaging structure cross section short side S122. The second major ground terminal engaging structure cross section long side S121 and the second major ground terminal engaging structure cross section short side S122 are respectively located at the long side and the short side of the second major ground terminal engaging structure cross section A12.

It should be noted that the major signal terminal engaging structure cross section long side S101 is extended along the major terminal engaging structure arrangement region long side S11, and the major signal terminal engaging structure cross section short side S102 is extended along the major terminal engaging structure arrangement region short side S12. The first major ground terminal engaging structure cross section long side S111 is extended along the major terminal engaging structure arrangement region short side S12, and the extension length of the first major ground terminal engaging structure cross section long side S111 is greater than that of the major signal terminal engaging structure cross section short side S102. Accordingly, the first major ground terminal engaging structure 1111 can provide shielding for the major signal terminal engaging structure 1101 at the major terminal engaging structure arrangement region short side S12, thereby reducing the degree of interference with signal transmission of the major signal terminal engaging structure 1101 and satisfying the signal transmission requirement of the electrical connector 1. Likewise, the second major ground terminal engaging structure cross section long side S121 is extended along the major terminal engaging structure arrangement region short side S12, and the extension length of the second major ground terminal engaging structure cross section long side S121 is greater than that of the major signal terminal engaging structure cross section short side S102, such that the second major ground terminal engaging structure 1121 can provide shielding for the major signal terminal engaging structure 1101 at the major terminal engaging structure arrangement region short side S12, thereby reducing the degree of interference with signal transmission of the major signal terminal engaging structure 1101 and satisfying the signal transmission requirement of the electrical connector 1.

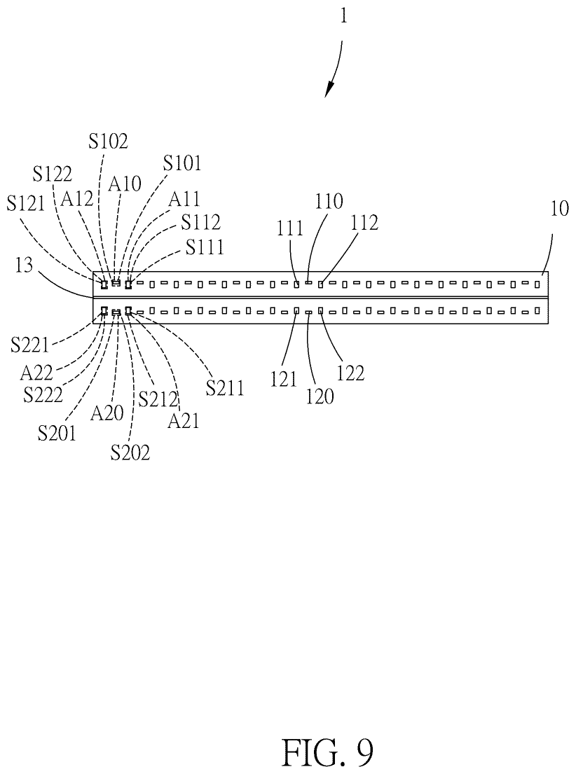

In the embodiment shown in FIGS. 9 to 12, the major terminal engaging structure arrangement region Z1 comprises a major signal terminal engaging structure arrangement subregion Z10, a first major ground terminal engaging structure arrangement subregion Z11, and a second major ground terminal engaging structure arrangement subregion Z12. The major signal terminal engaging structure arrangement subregion Z10 is located between the first major ground terminal engaging structure arrangement subregion Z11 and the second major ground terminal engaging structure arrangement subregion Z12. The major signal terminal engaging structure arrangement subregion Z10, the first major ground terminal engaging structure arrangement subregion Z11, and the second major ground terminal engaging structure arrangement subregion Z12 are respectively used to arrange the major signal terminal engaging structure 1101, the first major ground terminal engaging structure 1111, and the second major ground terminal engaging structure 1121. Therefore, the major signal terminal 110 is located between the first major ground terminal 111 and the second major ground terminal 112.

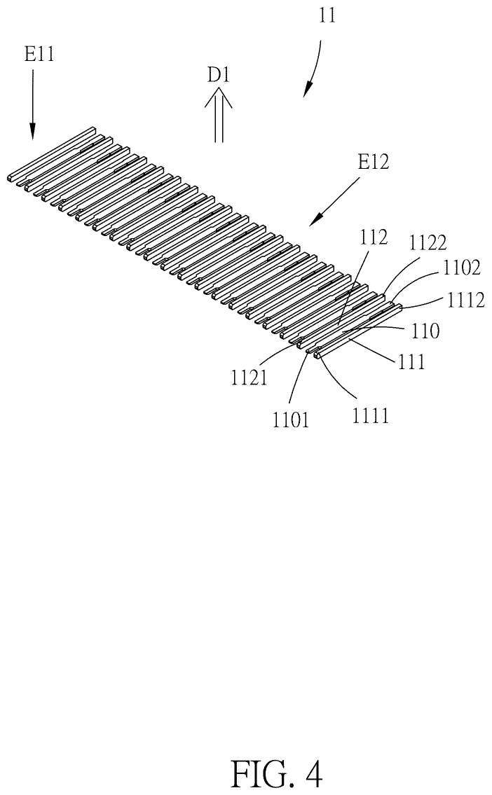

In the embodiment shown in FIG. 4, the first major ground terminal engaging structure 1111 and the second major ground terminal engaging structure 1121 are respectively located on both sides of the major signal terminal engaging structure 1101, such that the first major ground terminal engaging structure 1111 and the second major ground terminal engaging structure 1121 can provide a major engaging structure shielding environment for the major signal terminal engaging structure 1101. Moreover, the first major ground terminal 111 and the second major ground terminal 112 are respectively taller than the major signal terminal 110, such that the major signal terminal 110 is positioned within the major engaging structure shielding environment, thereby reducing the degree of interference with signal transmission of the major signal terminal 110 and satisfying the signal transmission requirement of the electrical connector 1.

Regarding the minor conductive terminal set 12, the two ends of the minor conductive terminal set 12 are respectively a minor conductive terminal set engaging end E21 and a minor conductive terminal set joining end E22.

The minor conductive terminal set 12 comprises a minor signal terminal 120, a first minor ground terminal 121, and a second minor ground terminal 122, wherein the first minor ground terminal 121 and the second minor ground terminal 122 are configured to transmit ground signals, which, in the above embodiment, are shielding signals. The minor signal terminal 120, the first minor ground terminal 121, and the second minor ground terminal 122 respectively comprise a minor signal terminal engaging structure 1201, a first minor ground terminal engaging structure 1211, and a second minor ground terminal engaging structure 1221 at the minor conductive terminal set engaging end E21. The minor signal terminal engaging structure 1201, the first minor ground terminal engaging structure 1211, and the second minor ground terminal engaging structure 1221 are respectively arranged in the minor terminal engaging structure arrangement region Z2 and extend in a minor engaging direction D2 to engage the engaging conductive component 2, wherein the major engaging direction D1 and the minor engaging direction D2 are substantially different.

In the embodiment shown in FIG. 11, the extension length of the minor signal terminal engaging structure 1201 in the minor engaging direction D2 is a minor signal terminal engaging structure extension length L20. The extension length of the first minor ground terminal engaging structure 1211 in the minor engaging direction D2 is a first minor ground terminal engaging structure extension length L21. The extension length of the second minor ground terminal engaging structure 1221 in the minor engaging direction D2 is a second minor ground terminal engaging structure extension length L22.

It should be noted that the first minor ground terminal engaging structure extension length L21 is greater than the minor signal terminal engaging structure extension length L20, such that the first minor ground terminal engaging structure 1211 can provide shielding for the minor signal terminal engaging structure 1201 to reduce the degree of interference with signal transmission of the minor signal terminal engaging structure 1201 and satisfy the signal transmission requirement of the electrical connector 1. Similarly, the second minor ground terminal engaging structure extension length L22 is greater than the minor signal terminal engaging structure extension length L20, such that the second minor ground terminal engaging structure 1221 can provide shielding for the minor signal terminal engaging structure 1201 to reduce the degree of interference with signal transmission of the minor signal terminal engaging structure 1201 and satisfy the signal transmission requirement of the electrical connector 1.

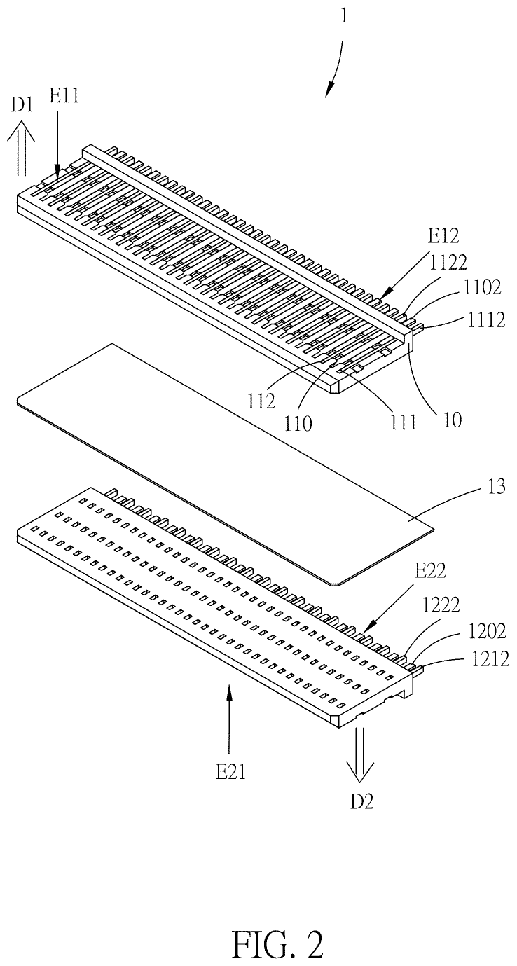

In addition, the minor signal terminal 120, the first minor ground terminal 121, and the second minor ground terminal 122 respectively comprise a minor signal terminal joining structure 1202, a first minor ground terminal joining structure 1212, and a second minor ground terminal joining structure 1222 at the minor conductive terminal set joining end E22. The minor signal terminal joining structure 1202, the first minor ground terminal joining structure 1212, and the second minor ground terminal joining structure 1222 are configured to join the joining conductive component 3. The minor signal terminal joining structure 1202 is located between the first minor ground terminal joining structure 1212 and the second minor ground terminal joining structure 1222. In the embodiments shown in FIGS. 2 to 3, 7 to 8, 10, 13 to 17, 19, 21 to 25, 27 to 33, 35 to 37, 40 to 42, and 45 to 48, the conductive metal connecting component 13 is extended from the minor conductive terminal set engaging end E21 to the minor conductive terminal set joining end E22 to provide shielding for the minor signal terminal engaging structure 1201 and the minor signal terminal joining structure 1202, thereby reducing the degree of interference with signal transmission of the minor signal terminal engaging structure 1201 and the minor signal terminal joining structure 1202 and satisfying the signal transmission requirement of the electrical connector 1.

In the above embodiment, the cross section of the minor signal terminal engaging structure 1201 in the minor terminal engaging structure arrangement region Z2 is a minor signal terminal engaging structure cross section A20, which is a rectangular cross section and comprises a minor signal terminal engaging structure cross section long side S201 and a minor signal terminal engaging structure cross section short side S202. The minor signal terminal engaging structure cross section long side S201 and the minor signal terminal engaging structure cross section short side S202 are respectively located at the long side and the short side of the minor signal terminal engaging structure cross section A20.

In addition, the cross section of the first minor ground terminal engaging structure 1211 in the minor terminal engaging structure arrangement region Z2 is a first minor ground terminal engaging structure cross section A21, which is a rectangular cross section and comprises a first minor ground terminal engaging structure cross section long side S211 and a first minor ground terminal engaging structure cross section short side S212. The first minor ground terminal engaging structure cross section long side S211 and the first minor ground terminal engaging structure cross section short side S212 are respectively located at the long side and the short side of the first minor ground terminal engaging structure cross section A21.

Furthermore, the cross section of the second minor ground terminal engaging structure 1221 in the minor terminal engaging structure arrangement region Z2 is a second minor ground terminal engaging structure cross section A22, which is a rectangular cross section and comprises a second minor ground terminal engaging structure cross section long side S221 and a second minor ground terminal engaging structure cross section short side S222. The second minor ground terminal engaging structure cross section long side S221 and the second minor ground terminal engaging structure cross section short side S222 are respectively located at the long side and the short side of the second minor ground terminal engaging structure cross section A22.

It should be noted that the minor signal terminal engaging structure cross section long side S201 is extended along the minor terminal engaging structure arrangement region long side S21, and the minor signal terminal engaging structure cross section short side S202 is extended along the minor terminal engaging structure arrangement region short side S22. The first minor ground terminal engaging structure cross section long side S211 is extended along the minor terminal engaging structure arrangement region short side S22, and its extension length is greater than that of the minor signal terminal engaging structure cross section short side S202.

Accordingly, the first minor ground terminal engaging structure 1211 can provide shielding for the minor signal terminal engaging structure 1201 at the minor terminal engaging structure arrangement region short side S22, thereby reducing the degree of interference with signal transmission of the minor signal terminal engaging structure 1201 and satisfying the signal transmission requirement of the electrical connector 1. Likewise, the second minor ground terminal engaging structure cross section long side S221 is extended along the minor terminal engaging structure arrangement region short side S22, and its extension length is greater than that of the minor signal terminal engaging structure cross section short side S202, such that the second minor ground terminal engaging structure 1221 can provide shielding for the minor signal terminal engaging structure 1201 at the minor terminal engaging structure arrangement region short side S22, thereby reducing the degree of interference with signal transmission of the minor signal terminal engaging structure 1201 and satisfying the signal transmission requirement of the electrical connector 1.

In the embodiment shown in FIGS. 9 to 12, the minor terminal engaging structure arrangement region Z2 comprises a minor signal terminal engaging structure arrangement subregion Z20, a first minor ground terminal engaging structure arrangement subregion Z21, and a second minor ground terminal engaging structure arrangement subregion Z22. The minor signal terminal engaging structure arrangement subregion Z20 is located between the first minor ground terminal engaging structure arrangement subregion Z21 and the second minor ground terminal engaging structure arrangement subregion Z22. The minor signal terminal engaging structure arrangement subregion Z20, the first minor ground terminal engaging structure arrangement subregion Z21, and the second minor ground terminal engaging structure arrangement subregion Z22 are respectively configured to arrange the minor signal terminal engaging structure 1201, the first minor ground terminal engaging structure 1211, and the second minor ground terminal engaging structure 1221. Therefore, the minor signal terminal 120 is located between the first minor ground terminal 121 and the second minor ground terminal 122.

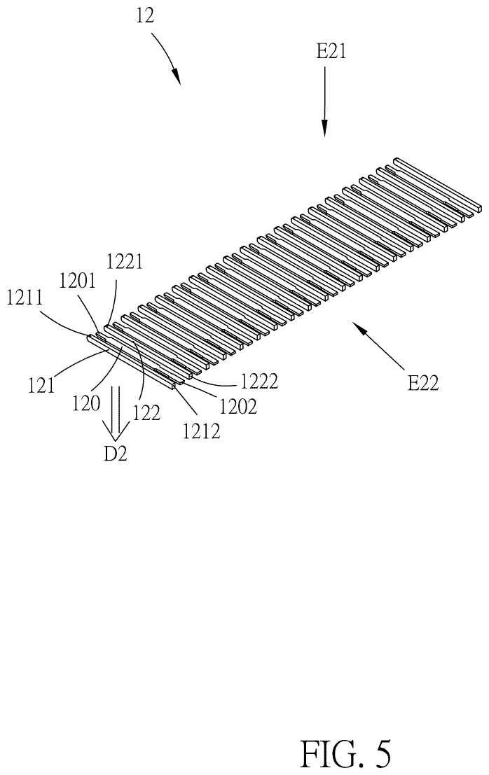

In the embodiment shown in FIG. 5, the first minor ground terminal engaging structure 1211 and the second minor ground terminal engaging structure 1221 are respectively located on both sides of the minor signal terminal engaging structure 1201, such that the first minor ground terminal engaging structure 1211 and the second minor ground terminal engaging structure 1221 can provide a minor engaging structure shielding environment for the minor signal terminal engaging structure 1201. Additionally, the first minor ground terminal 121 and the second minor ground terminal 122 are respectively taller than the minor signal terminal 120, thereby positioning the minor signal terminal 120 within the minor engaging structure shielding environment.

Regarding the conductive metal connecting component 13, the conductive metal connecting component 13 is disposed between the major conductive terminal set 11 and the minor conductive terminal set 12, and is optionally made of conductive metal to provide transmission of a shielding signal such as a ground signal, absorb electromagnetic waves, and/or provide electrical shielding. In the above embodiment, the conductive metal connecting component 13 crosses over the major signal terminal 110 and the minor signal terminal 120 and is electrically connected to the first major ground terminal 111, the first minor ground terminal 121, the second major ground terminal 112, and the second minor ground terminal 122, so as to transmit a shielding signal such as a ground signal and provide shielding respectively for the major conductive terminal set 11 and the minor conductive terminal set 12, thereby reducing the degree of interference with signal transmission and satisfying the signal transmission requirement of the electrical connector 1.

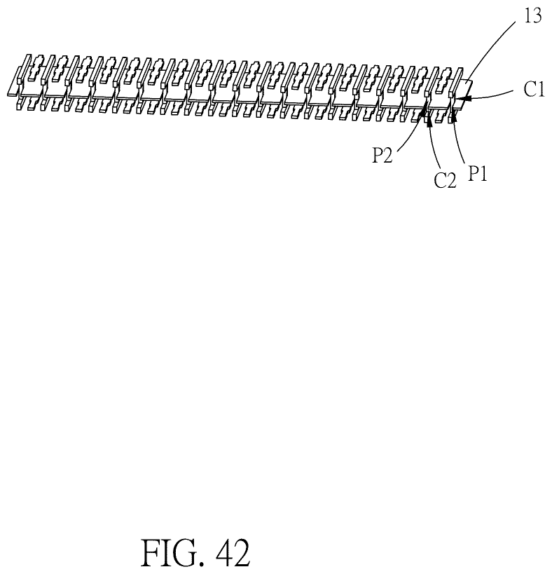

In the embodiment shown in FIG. 42, the electrical connector 1 further comprises a first ground terminal connecting member C1 and a second ground terminal connecting member C2. The first ground terminal connecting member C1 connects the first major ground terminal 111 and the first minor ground terminal 121 such that the first ground terminal connecting member C1, the first major ground terminal 111, and the first minor ground terminal 121 form an I shaped structure to enhance structural strength and electrically connect the first major ground terminal 111 and the first minor ground terminal 121 for transmitting a shielding signal such as a ground signal. The second ground terminal connecting member C2 connects the second major ground terminal 112 and the second minor ground terminal 122 such that the second ground terminal connecting member C2, the second major ground terminal 112, and the second minor ground terminal 122 form an I shaped structure to enhance structural strength and electrically connect the second major ground terminal 112 and the second minor ground terminal 122 for transmitting a shielding signal such as a ground signal. Accordingly, the conductive metal connecting component 13 comprises a first connecting member passage P1 and a second connecting member passage P2, wherein the first ground terminal connecting member C1 passes through and is electrically connected to the conductive metal connecting component 13 via the first connecting member passage P1, and the second ground terminal connecting member C2 passes through and is electrically connected to the conductive metal connecting component 13 via the second connecting member passage P2.

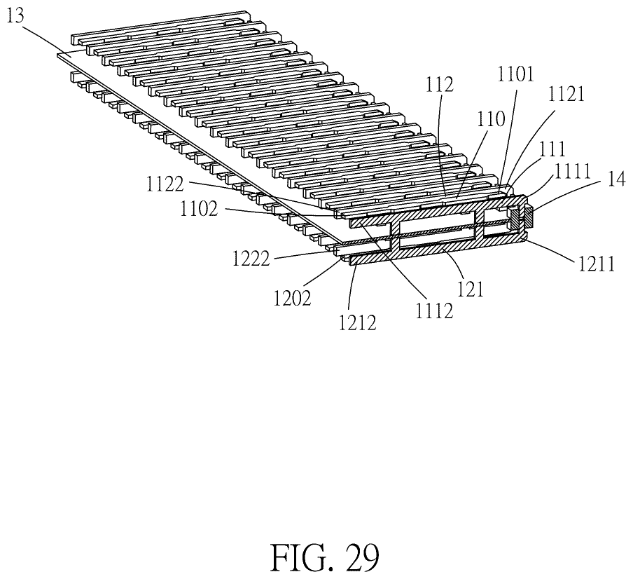

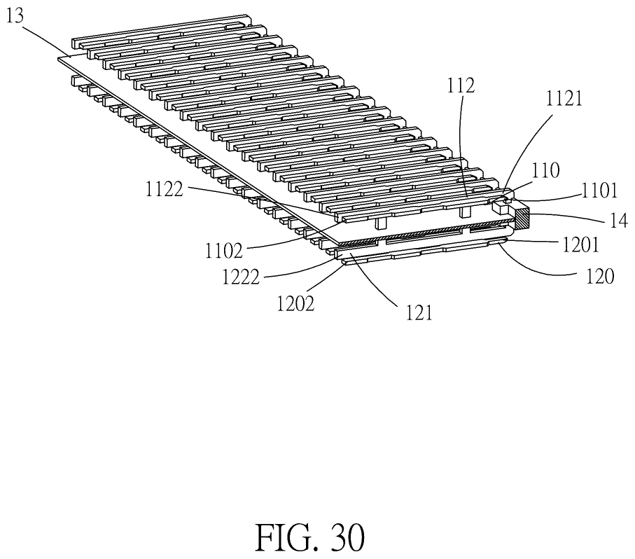

In the embodiment shown in FIGS. 29 to 30, the first major ground terminal 111, the second major ground terminal 112, the first minor ground terminal 121, and the second minor ground terminal 122 are respectively abutted against the conductive metal connecting component 13, such that they are electrically connected to the conductive metal connecting component 13.

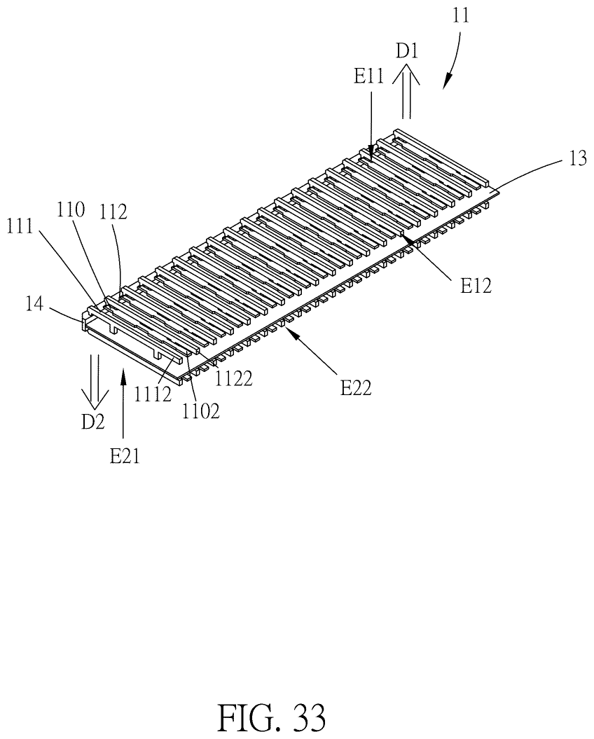

The conductive plastic connecting component 14 is optionally made of conductive plastic and is capable of transmitting a shielding signal such as a ground signal, absorbing electromagnetic waves, and/or providing electrical shielding. Regarding the conductive plastic connecting component 14, in the embodiment shown in FIGS. 33 to 36, the conductive plastic connecting component 14 respectively crosses over the major signal terminal 110 and the minor signal terminal 120. The first major ground terminal 111, the second major ground terminal 112, the first minor ground terminal 121, and the second minor ground terminal 122 are respectively abutted against the conductive plastic connecting component 14. The conductive metal connecting component 13 is inserted into the conductive plastic connecting component 14, so that the conductive plastic connecting component 14 can electrically connect the first major ground terminal 111, the second major ground terminal 112, the first minor ground terminal 121, the second minor ground terminal 122, and the conductive metal connecting component 13 to transmit a shielding signal such as a ground signal.

Additionally, regarding the conductive plastic connecting component 14, in the embodiment shown in FIG. 29, the conductive plastic connecting component 14 is inserted respectively by the first major ground terminal 111, the second major ground terminal 112, the first minor ground terminal 121, and the second minor ground terminal 122, and the conductive metal connecting component 13 is abutted against the conductive plastic connecting component 14. Accordingly, the conductive plastic connecting component 14 can electrically connect the first major ground terminal 111, the second major ground terminal 112, the first minor ground terminal 121, the second minor ground terminal 122, and the conductive metal connecting component 13 to transmit a shielding signal such as a ground signal.

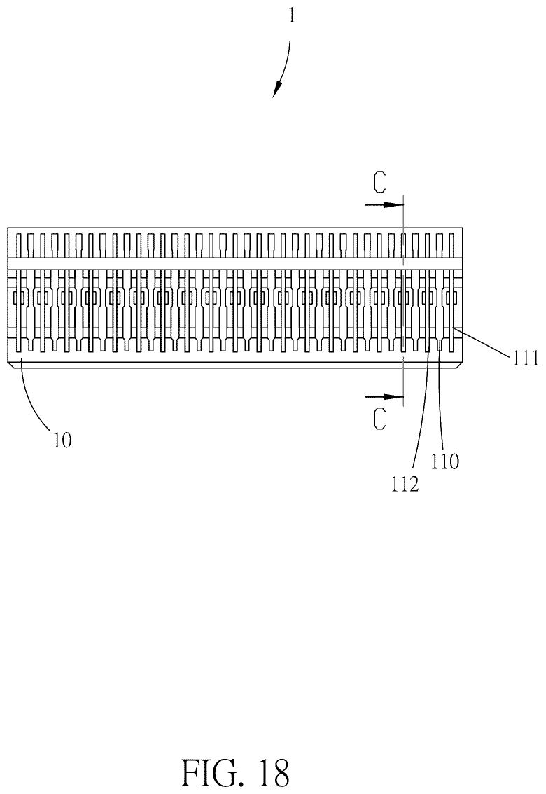

Furthermore, regarding the conductive plastic connecting component 14, in the embodiment shown in FIGS. 18 to 21, the conductive plastic connecting component 14 comprises: a major conductive plastic connecting subcomponent 141 and a minor conductive plastic connecting subcomponent 142. The major conductive plastic connecting subcomponent 141 is configured to electrically connect the first major ground terminal 111, the second major ground terminal 112, and the conductive metal connecting component 13 to transmit a shielding signal such as a ground signal. The minor conductive plastic connecting subcomponent 142 is configured to electrically connect the first minor ground terminal 121, the second minor ground terminal 122, and the conductive metal connecting component 13 to transmit a shielding signal such as a ground signal.

It should be noted that, in the embodiments of the present application, the conductive component module and its electrical connector may optionally omit the aforementioned components. For example, the electrical connector of the present application may optionally comprise: an electrical connector body and a major conductive terminal set. The electrical connector body comprises a major terminal engaging structure arrangement region, which comprises a major terminal engaging structure arrangement region long side and a major terminal engaging structure arrangement region short side, located respectively at the long side and the short side of the major terminal engaging structure arrangement region. One end of the major conductive terminal set is a major conductive terminal set engaging end. The major conductive terminal set comprises a major signal terminal and a first major ground terminal. The major signal terminal and the first major ground terminal respectively comprise a major signal terminal engaging structure and a first major ground terminal engaging structure at the engaging end. The major signal terminal engaging structure and the first major ground terminal engaging structure are respectively arranged in the major terminal engaging structure arrangement region. The cross section of the major signal terminal engaging structure in the major terminal engaging structure arrangement region is a major signal terminal engaging structure cross section comprising a major signal terminal engaging structure cross section long side and a major signal terminal engaging structure cross section short side, located respectively at the long side and the short side of the major signal terminal engaging structure cross section. The cross section of the first major ground terminal engaging structure in the major terminal engaging structure arrangement region is a first major ground terminal engaging structure cross section comprising a first major ground terminal engaging structure cross section long side and a first major ground terminal engaging structure cross section short side, located respectively at the long side and the short side of the first major ground terminal engaging structure cross section. The long side of the major signal terminal engaging structure cross section is extended along the major terminal engaging structure arrangement region long side, and the short side is extended along the short side. The long side of the first major ground terminal engaging structure cross section is extended along the short side, and its extension length is greater than that of the short side of the major signal terminal engaging structure cross section, such that the first major ground terminal engaging structure can provide shielding for the major signal terminal engaging structure at the short side.

Additionally, the electrical connector of the present application may optionally comprise: a major conductive terminal set. One end of the major conductive terminal set is a major conductive terminal set engaging end. The major conductive terminal set comprises a major signal terminal and a first major ground terminal. The major signal terminal and the first major ground terminal respectively comprise a major signal terminal engaging structure and a first major ground terminal engaging structure at the engaging end. The major signal terminal engaging structure and the first major ground terminal engaging structure respectively are extended in a major engaging direction. The extension length of the major signal terminal engaging structure in the major engaging direction is a major signal terminal engaging structure extension length, and the extension length of the first major ground terminal engaging structure in the major engaging direction is a first major ground terminal engaging structure extension length. The first major ground terminal engaging structure extension length is greater than the major signal terminal engaging structure extension length, such that the first major ground terminal engaging structure can provide shielding for the major signal terminal engaging structure.

Furthermore, the electrical connector of the present application may optionally comprise: a major conductive terminal set. One end of the major conductive terminal set is a major conductive terminal set engaging end. The major conductive terminal set comprises a major signal terminal, a first major ground terminal, and a second major ground terminal. The major signal terminal, the first major ground terminal, and the second major ground terminal respectively comprise a major signal terminal engaging structure, a first major ground terminal engaging structure, and a second major ground terminal engaging structure at the engaging end. The first major ground terminal engaging structure and the second major ground terminal engaging structure are respectively located on both sides of the major signal terminal engaging structure, such that the first major ground terminal engaging structure and the second major ground terminal engaging structure can provide a major engaging structure shielding environment for the major signal terminal engaging structure. Additionally, the first major ground terminal and the second major ground terminal are respectively taller than the major signal terminal, such that the major signal terminal is positioned within the major engaging structure shielding environment.

In addition, the conductive component module of the present application may optionally comprise: an engaging conductive component, a joining conductive component, and an electrical connector. The major signal terminal engaging structure, the first major ground terminal engaging structure, the second major ground terminal engaging structure, the minor signal terminal engaging structure, the first minor ground terminal engaging structure, and the second minor ground terminal engaging structure are configured to engage the engaging conductive component. The major signal terminal joining structure, the first major ground terminal joining structure, the second major ground terminal joining structure, the minor signal terminal joining structure, the first minor ground terminal joining structure, and the second minor ground terminal joining structure are configured to join the joining conductive component.

In summary, the present application provides a conductive component module and its electrical connector, wherein the conductive component module comprises: an engaging conductive component, a joining conductive component, and an electrical connector. The electrical connector comprises a conductive terminal set that can engage the engaging conductive component to transmit signals, and also join the joining conductive component to transmit signals. The conductive terminal set comprises a ground terminal and a signal terminal, wherein the ground terminal is configured to provide shielding for the signal terminal to reduce the degree of interference with signal transmission of the signal terminal, thereby meeting the signal transmission requirement of the electrical connector.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector comprising:
an electrical connector body comprising a major terminal engaging structure arrangement region, the major terminal engaging structure arrangement region comprising a major terminal engaging structure arrangement region long side and a major terminal engaging structure arrangement region short side, wherein the major terminal engaging structure arrangement region long side is located at a long side of the major terminal engaging structure arrangement region, and the major terminal engaging structure arrangement region short side is located at a short side of the major terminal engaging structure arrangement region; and
a major conductive terminal set, one end of the major conductive terminal set being a major conductive terminal set engaging end, the major conductive terminal set comprising a major signal terminal and a first major ground terminal, wherein the major signal terminal and the first major ground terminal respectively comprise a major signal terminal engaging structure and a first major ground terminal engaging structure at the major conductive terminal set engaging end, and the major signal terminal engaging structure and the first major ground terminal engaging structure are provided in the major terminal engaging structure arrangement region, wherein,
a cross section of the major signal terminal engaging structure in the major terminal engaging structure arrangement region is a major signal terminal engaging structure cross section, the major signal terminal engaging structure cross section comprising a major signal terminal engaging structure cross section long side and a major signal terminal engaging structure cross section short side which are respectively located at a long side and a short side of the major signal terminal engaging structure cross section;
a cross section of the first major ground terminal engaging structure in the major terminal engaging structure arrangement region is a first major ground terminal engaging structure cross section, the first major ground terminal engaging structure cross section comprising a first major ground terminal engaging structure cross section long side and a first major ground terminal engaging structure cross section short side which are respectively located at a long side and a short side of the first major ground terminal engaging structure cross section;
the major signal terminal engaging structure cross section long side is extended along the major terminal engaging structure arrangement region long side, and the major signal terminal engaging structure cross section short side is extended along the major terminal engaging structure arrangement region short side; and
the first major ground terminal engaging structure cross section long side is extended along the major terminal engaging structure arrangement region short side, and an extension length of the first major ground terminal engaging structure cross section long side is greater than an extension length of the major signal terminal engaging structure cross section short side, such that the first major ground terminal engaging structure provides shielding for the major signal terminal engaging structure at the major terminal engaging structure arrangement region short side.

2. The electrical connector of claim 1, wherein the electrical connector body further comprises a minor terminal engaging structure arrangement region, and the minor terminal engaging structure arrangement region comprises a minor terminal engaging structure arrangement region long side and a minor terminal engaging structure arrangement region short side, wherein the minor terminal engaging structure arrangement region long side and the minor terminal engaging structure arrangement region short side are respectively located at a long side and a short side of the minor terminal engaging structure arrangement region, and the electrical connector further comprises a minor conductive terminal set and a conductive metal connecting component, wherein,
one end of the minor conductive terminal set is a minor conductive terminal set engaging end, and the minor conductive terminal set comprises a minor signal terminal and a first minor ground terminal which respectively comprise a minor signal terminal engaging structure and a first minor ground terminal engaging structure at the minor conductive terminal set engaging end, wherein the minor signal terminal engaging structure and the first minor ground terminal engaging structure are provided in the minor terminal engaging structure arrangement region;
a cross section of the minor signal terminal engaging structure in the minor terminal engaging structure arrangement region is a minor signal terminal engaging structure cross section, the minor signal terminal engaging structure cross section comprising a minor signal terminal engaging structure cross section long side and a minor signal terminal engaging structure cross section short side which are respectively located at a long side and a short side of the minor signal terminal engaging structure cross section;
a cross section of the first minor ground terminal engaging structure in the minor terminal engaging structure arrangement region is a first minor ground terminal engaging structure cross section, the minor ground terminal engaging structure cross section comprising a first minor ground terminal engaging structure cross section long side and a first minor ground terminal engaging structure cross section short side which are respectively located at a long side and a short side of the minor ground terminal engaging structure cross section;
the minor signal terminal engaging structure cross section long side is extended along the minor terminal engaging structure arrangement region long side, and the minor signal terminal engaging structure cross section short side is extended along the minor terminal engaging structure arrangement region short side; and
the first minor ground terminal engaging structure cross section long side is extended along the minor terminal engaging structure arrangement region short side, and an extension length of the first minor ground terminal engaging structure cross section long side is greater than an extension length of the minor signal terminal engaging structure cross section short side, such that the first minor ground terminal engaging structure provides shielding for the minor signal terminal engaging structure at the minor terminal engaging structure arrangement region short side; and
the conductive metal connecting component is located between the major conductive terminal set and the minor conductive terminal set and is electrically connected to the first major ground terminal and the first minor ground terminal respectively to transmit a shielding signal and provide shielding for the major conductive terminal set and the minor conductive terminal set.

3. The electrical connector of claim 2, wherein the major conductive terminal set further comprises a second major ground terminal, the second major ground terminal comprising a second major ground terminal engaging structure at the major conductive terminal set engaging end, the second major ground terminal engaging structure being provided in the major terminal engaging structure arrangement region, wherein a cross section of the second major ground terminal engaging structure in the major terminal engaging structure arrangement region is a second major ground terminal engaging structure cross section, the second major ground terminal engaging structure cross section comprising a second major ground terminal engaging structure cross section long side and a second major ground terminal engaging structure cross section short side which are respectively located at a long side and a short side of the second major ground terminal engaging structure cross section; wherein the second major ground terminal engaging structure cross section long side is extended along the major terminal engaging structure arrangement region short side, and an extension length of the second major ground terminal engaging structure cross section long side is greater than the extension length of the major signal terminal engaging structure cross section short side, such that the second major ground terminal engaging structure provides shielding for the major signal terminal engaging structure at the major terminal engaging structure arrangement region short side; and the major terminal engaging structure arrangement region comprises a major signal terminal engaging structure arrangement subregion, a first major ground terminal engaging structure arrangement subregion, and a second major ground terminal engaging structure arrangement subregion, wherein the major signal terminal engaging structure arrangement subregion is located between the first major ground terminal engaging structure arrangement subregion and the second major ground terminal engaging structure arrangement subregion, and wherein the major signal terminal engaging structure arrangement subregion is configured to accommodate the major signal terminal engaging structure, the first major ground terminal engaging structure arrangement subregion is configured to accommodate the first major ground terminal engaging structure, and the second major ground terminal engaging structure arrangement subregion is configured to accommodate the second major ground terminal engaging structure.

4. The electrical connector of claim 3, wherein the minor conductive terminal set further comprises a second minor ground terminal, the second minor ground terminal comprising a second minor ground terminal engaging structure at the minor conductive terminal set engaging end, the second minor ground terminal engaging structure being provided in the minor terminal engaging structure arrangement region, wherein a cross section of the second minor ground terminal engaging structure in the minor terminal engaging structure arrangement region is a second minor ground terminal engaging structure cross section, the second minor ground terminal engaging structure cross section comprising a second minor ground terminal engaging structure cross section long side and a second minor ground terminal engaging structure cross section short side which are respectively located at a long side and a short side of the second minor ground terminal engaging structure cross section; the second minor ground terminal engaging structure cross section long side is extended along the minor terminal engaging structure arrangement region short side, and an extension length of the second minor ground terminal engaging structure cross section long side is greater than the extension length of the minor signal terminal engaging structure cross section short side, such that the second minor ground terminal engaging structure provides shielding for the minor signal terminal engaging structure at the minor terminal engaging structure arrangement region short side; and the minor terminal engaging structure arrangement region comprises a minor signal terminal engaging structure arrangement subregion, a first minor ground terminal engaging structure arrangement subregion, and a second minor ground terminal engaging structure arrangement subregion, wherein the minor signal terminal engaging structure arrangement subregion is located between the first minor ground terminal engaging structure arrangement subregion and the second minor ground terminal engaging structure arrangement subregion, and wherein the minor signal terminal engaging structure arrangement subregion is configured to accommodate the minor signal terminal engaging structure, the first minor ground terminal engaging structure arrangement subregion is configured to accommodate the first minor ground terminal engaging structure, and the second minor ground terminal engaging structure arrangement subregion is configured to accommodate the second minor ground terminal engaging structure; and the conductive metal connecting component is further electrically connected to the second major ground terminal and the second minor ground terminal to transmit the shielding signal and provide shielding to the major conductive terminal set and the minor conductive terminal set.

5. The electrical connector of claim 4, wherein the major terminal engaging structure arrangement region is a rectangular region; the major signal terminal engaging structure cross section is a rectangular cross section; the first major ground terminal engaging structure cross section is a rectangular cross section; the second major ground terminal engaging structure cross section is a rectangular cross section;
the minor terminal engaging structure arrangement region is a rectangular region; the minor signal terminal engaging structure cross section is a rectangular cross section; the first minor ground terminal engaging structure cross section is a rectangular cross section; and the second minor ground terminal engaging structure cross section is a rectangular cross section.

6. The electrical connector of claim 4, further comprising:
a major conductive plastic connecting subcomponent configured to be electrically connected to the first major ground terminal, the second major ground terminal, and the conductive metal connecting component respectively, so as to transmit the shielding signal; and
a minor conductive plastic connecting subcomponent configured to be electrically connected to the first minor ground terminal, the second minor ground terminal, and the conductive metal connecting component respectively, so as to transmit the shielding signal.

7. The electrical connector of claim 4, further comprising a conductive plastic connecting component, wherein the first major ground terminal, the second major ground terminal, the first minor ground terminal, and the second minor ground terminal respectively abut the conductive plastic connecting component, and the conductive metal connecting component is inserted into the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

8. The electrical connector of claim 4, further comprising a conductive plastic connecting component, wherein the first major ground terminal, the second major ground terminal, the first minor ground terminal, and the second minor ground terminal are respectively inserted into the conductive plastic connecting component, and the conductive metal connecting component abuts the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

9. The electrical connector of claim 4, wherein another end of the major conductive terminal set is a major conductive terminal set joining end, and the major signal terminal comprises a major signal terminal joining structure at the major conductive terminal set joining end, wherein the conductive metal connecting component is extended from the major conductive terminal set engaging end to the major conductive terminal set joining end, so as to provide shielding for the major signal terminal engaging structure and the major signal terminal joining structure respectively; and another end of the minor conductive terminal set is a minor conductive terminal set joining end, and the minor signal terminal comprises a minor signal terminal joining structure at the minor conductive terminal set joining end, wherein the conductive metal connecting component is extended from the minor conductive terminal set engaging end to the minor conductive terminal set joining end, so as to provide shielding for the minor signal terminal engaging structure and the minor signal terminal joining structure respectively.

10. The electrical connector of claim 4, further comprising a first ground terminal connecting member and a second ground terminal connecting member, wherein the first ground terminal connecting member is connected to the first major ground terminal and the first minor ground terminal, such that the first ground terminal connecting member, the first major ground terminal, and the first minor ground terminal form an I shaped structure, and the first ground terminal connecting member is electrically connected to the first major ground terminal and the first minor ground terminal; the second ground terminal connecting member is connected to the second major ground terminal and the second minor ground terminal, such that the second ground terminal connecting member, the second major ground terminal, and the second minor ground terminal form an I shaped structure, and the second ground terminal connecting member is electrically connected to the second major ground terminal and the second minor ground terminal; the conductive metal connecting component comprises a first connecting member passage and a second connecting member passage, wherein the first ground terminal connecting member passes through the first connecting member passage and is electrically connected to the conductive metal connecting component, and the second ground terminal connecting member passes through the second connecting member passage and is electrically connected to the conductive metal connecting component.

11. The electrical connector of claim 4, wherein the first major ground terminal, the second major ground terminal, the first minor ground terminal, and the second minor ground terminal respectively abut the conductive metal connecting component, such that the first major ground terminal, the second major ground terminal, the first minor ground terminal, and the second minor ground terminal are respectively electrically connected to the conductive metal connecting component.

12. An electrical connector comprising:
a major conductive terminal set, one end of the major conductive terminal set being a major conductive terminal set engaging end, the major conductive terminal set comprising a major signal terminal and a first major ground terminal, wherein the major signal terminal and the first major ground terminal respectively comprise a major signal terminal engaging structure and a first major ground terminal engaging structure at the major conductive terminal set engaging end, and the major signal terminal engaging structure and the first major ground terminal engaging structure are extended respectively toward a major engaging direction, wherein,
an extension length of the major signal terminal engaging structure in the major engaging direction is a major signal terminal engaging structure extension length;
an extension length of the first major ground terminal engaging structure in the major engaging direction is a first major ground terminal engaging structure extension length; and
the first major ground terminal engaging structure extension length is greater than the major signal terminal engaging structure extension length, such that the first major ground terminal engaging structure provides shielding for the major signal terminal engaging structure.

13. The electrical connector of claim 12, further comprising:
a minor conductive terminal set, one end of the minor conductive terminal set being a minor conductive terminal set engaging end, the minor conductive terminal set comprising a minor signal terminal and a first minor ground terminal, wherein the minor signal terminal and the first minor ground terminal respectively comprise a minor signal terminal engaging structure and a first minor ground terminal engaging structure at the minor conductive terminal set engaging end, and the minor signal terminal engaging structure and the first minor ground terminal engaging structure are extended respectively toward a minor engaging direction, wherein,
an extension length of the minor signal terminal engaging structure in the minor engaging direction is a minor signal terminal engaging structure extension length;
an extension length of the first minor ground terminal engaging structure in the minor engaging direction is a first minor ground terminal engaging structure extension length; and
the first minor ground terminal engaging structure extension length is greater than the minor signal terminal engaging structure extension length, such that the first minor ground terminal engaging structure provides shielding for the minor signal terminal engaging structure; and
a conductive metal connecting component disposed between the major conductive terminal set and the minor conductive terminal set, and electrically connected to the first major ground terminal and the first minor ground terminal respectively, so as to transmit a shielding signal and provide shielding for the major conductive terminal set and the minor conductive terminal set respectively.

14. The electrical connector of claim 13, wherein the major conductive terminal set further comprises a second major ground terminal, wherein,
the second major ground terminal comprises a second major ground terminal engaging structure at the major conductive terminal set engaging end, wherein the second major ground terminal engaging structure is extended along the major engaging direction;
an extension length of the second major ground terminal engaging structure in the major engaging direction is a second major ground terminal engaging structure extension length; and
the major signal terminal is located between the first major ground terminal and the second major ground terminal, and the second major ground terminal engaging structure extension length is greater than the major signal terminal engaging structure extension length, such that the second major ground terminal engaging structure provides shielding for the major signal terminal engaging structure.

15. The electrical connector of claim 14, wherein the minor conductive terminal set further comprises a second minor ground terminal, wherein,
the second minor ground terminal comprises a second minor ground terminal engaging structure at the minor conductive terminal set engaging end, wherein the second minor ground terminal engaging structure is extended along the minor engaging direction;
an extension length of the second minor ground terminal engaging structure in the minor engaging direction is a second minor ground terminal engaging structure extension length; and
the minor signal terminal is located between the first minor ground terminal and the second minor ground terminal, and the second minor ground terminal engaging structure extension length is greater than the minor signal terminal engaging structure extension length, such that the second minor ground terminal engaging structure provides shielding for the minor signal terminal engaging structure.

16. The electrical connector of claim 15, further comprising:
a major conductive plastic connecting subcomponent electrically connected to the first major ground terminal, the second major ground terminal, and the conductive metal connecting component respectively, so as to transmit the shielding signal; and
a minor conductive plastic connecting subcomponent electrically connected to the first minor ground terminal, the second minor ground terminal, and the conductive metal connecting component respectively, so as to transmit the shielding signal.

17. The electrical connector of claim 15, further comprising a conductive plastic connecting component, wherein the first major ground terminal, the second major ground terminal, the first minor ground terminal, and the second minor ground terminal respectively abut the conductive plastic connecting component, and the conductive metal connecting component is inserted into the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

18. The electrical connector of claim 15, further comprising a conductive plastic connecting component, wherein the first major ground terminal, the second major ground terminal, the first minor ground terminal, and the second minor ground terminal are respectively inserted into the conductive plastic connecting component, and the conductive metal connecting component abuts the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

19. The electrical connector of claim 15, wherein another end of the major conductive terminal set is a major conductive terminal set joining end, and the major signal terminal comprises a major signal terminal joining structure at the major conductive terminal set joining end, wherein the conductive metal connecting component is extended from the major conductive terminal set engaging end to the major conductive terminal set joining end so as to provide shielding for the major signal terminal engaging structure and the major signal terminal joining structure respectively; and another end of the minor conductive terminal set is a minor conductive terminal set joining end, and the minor signal terminal comprises a minor signal terminal joining structure at the minor conductive terminal set joining end, wherein the conductive metal connecting component is extended from the minor conductive terminal set engaging end to the minor conductive terminal set joining end so as to provide shielding for the minor signal terminal engaging structure and the minor signal terminal joining structure respectively.

20. The electrical connector of claim 15, further comprising a first ground terminal connecting member and a second ground terminal connecting member, the first ground terminal connecting member being electrically connected to the first major ground terminal and the first minor ground terminal, the second ground terminal connecting member being electrically connected to the second major ground terminal and the second minor ground terminal, wherein the conductive metal connecting component comprises a first connecting member passage and a second connecting member passage, wherein the first ground terminal connecting member passes through the first connecting member passage and is electrically connected to the conductive metal connecting component, and the second ground terminal connecting member passes through the second connecting member passage and is electrically connected to the conductive metal connecting component.

21. The electrical connector of claim 15, wherein the first major ground terminal, the second major ground terminal, the first minor ground terminal, and the second minor ground terminal respectively abut the conductive metal connecting component, such that the first major ground terminal, the second major ground terminal, the first minor ground terminal, and the second minor ground terminal are respectively electrically connected to the conductive metal connecting component.

22. An electrical connector comprising:
a major conductive terminal set, one end of the major conductive terminal set being a major conductive terminal set engaging end, the major conductive terminal set comprising a major signal terminal, a first major ground terminal, and a second major ground terminal which respectively comprise a major signal terminal engaging structure, a first major ground terminal engaging structure, and a second major ground terminal engaging structure at the major conductive terminal set engaging end, wherein,
the first major ground terminal engaging structure and the second major ground terminal engaging structure are respectively located at two opposite sides of the major signal terminal engaging structure, such that the first major ground terminal engaging structure and the second major ground terminal engaging structure provide a major engaging structure shielding environment for the major signal terminal engaging structure, and the first major ground terminal and the second major ground terminal are respectively taller than the major signal terminal, such that the major signal terminal is located within the major engaging structure shielding environment.

23. The electrical connector of claim 22, further comprising:
a minor conductive terminal set, one end of the minor conductive terminal set being a minor conductive terminal set engaging end, the minor conductive terminal set comprising a minor signal terminal, a first minor ground terminal, and a second minor ground terminal which respectively comprise a minor signal terminal engaging structure, a first minor ground terminal engaging structure, and a second minor ground terminal engaging structure at the minor conductive terminal set engaging end, wherein,
the first minor ground terminal engaging structure and the second minor ground terminal engaging structure are respectively located at two opposite sides of the minor signal terminal engaging structure, such that the first minor ground terminal engaging structure and the second minor ground terminal engaging structure provide a minor engaging structure shielding environment for the minor signal terminal engaging structure, and the first minor ground terminal and the second minor ground terminal are respectively taller than the minor signal terminal, such that the minor signal terminal is located within the minor engaging structure shielding environment; and
a conductive metal connecting component disposed between the major conductive terminal set and the minor conductive terminal set. and electrically connected to the first major ground terminal, the second major ground terminal, the first minor ground terminal, and the second minor ground terminal respectively, so as to transmit a shielding signal and provide shielding for the major conductive terminal set and the minor conductive terminal set respectively.

24. The electrical connector of claim 23, further comprising:
a major conductive plastic connecting subcomponent electrically connected to the first major ground terminal, the second major ground terminal, and the conductive metal connecting component respectively, so as to transmit the shielding signal; and
a minor conductive plastic connecting subcomponent electrically connected to the first minor ground terminal, the second minor ground terminal, and the conductive metal connecting component, so as to transmit the shielding signal.

25. The electrical connector of claim 23, further comprising a conductive plastic connecting component, wherein the first major ground terminal, the second major ground terminal, the first minor ground terminal, and the second minor ground terminal respectively abut the conductive plastic connecting component, and the conductive metal connecting component is inserted into the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

26. The electrical connector of claim 23, further comprising a conductive plastic connecting component, wherein the first major ground terminal, the second major ground terminal, the first minor ground terminal, and the second minor ground terminal are respectively inserted into the conductive plastic connecting component, and the conductive metal connecting component abuts the conductive plastic connecting component, such that the conductive plastic connecting component is electrically connected to the first major ground terminal, the second major ground terminal, the first minor ground terminal, the second minor ground terminal, and the conductive metal connecting component, so as to transmit the shielding signal.

27. The electrical connector of claim 23, wherein another end of the major conductive terminal set is a major conductive terminal set joining end, and the major signal terminal comprises a major signal terminal joining structure at the major conductive terminal set joining end, wherein the conductive metal connecting component is extended from the major conductive terminal set engaging end to the major conductive terminal set joining end so as to provide shielding for the major signal terminal engaging structure and the major signal terminal joining structure respectively; and another end of the minor conductive terminal set is a minor conductive terminal set joining end, and the minor signal terminal comprises a minor signal terminal joining structure at the minor conductive terminal set joining end, wherein the conductive metal connecting component is extended from the minor conductive terminal set engaging end to the minor conductive terminal set joining end so as to provide shielding for the minor signal terminal engaging structure and the minor signal terminal joining structure respectively.

28. The electrical connector of claim 23, wherein the electrical connector further comprises a first ground terminal connecting member and a second ground terminal connecting member, the first ground terminal connecting member being electrically connected to the first major ground terminal and the first minor ground terminal, the second ground terminal connecting member being electrically connected to the second major ground terminal and the second minor ground terminal, wherein the conductive metal connecting component comprises a first connecting member passage and a second connecting member passage, wherein the first ground terminal connecting member passes through the first connecting member passage and is electrically connected to the conductive metal connecting component, and the second ground terminal connecting member passes through the second connecting member passage and is electrically connected to the conductive metal connecting component.

29. The electrical connector of claim 23, wherein the first major ground terminal, the second major ground terminal, the first minor ground terminal, and the second minor ground terminal respectively abut the conductive metal connecting component, such that the first major ground terminal, the second major ground terminal, the first minor ground terminal, and the second minor ground terminal are respectively electrically connected to the conductive metal connecting component.
